(19) United States
(12) Patent Application Publication
(10) Pub. No.: US 2025/0271648 A1
(43) Pub. Date: Aug. 28, 2025

(54) ZOOM LENS AND IMAGING APPARATUS

(71) Applicant: Tamron Co., Ltd., Saitama (JP)

(72) Inventor: Hisayuki Yamanaka, Saitama (JP)

(73) Assignee: Tamron Co., Ltd., Saitama (JP)

(21) Appl. No.: 18/964,680

(22) Filed: Dec. 2, 2024

(30) Foreign Application Priority Data
Feb. 28, 2024 (JP) 2024-028943

(51) Int. Cl. G02B 15/14; G02B 15/16

(52) U.S. Cl. CPC G02B 15/1461; G02B 15/16

(57) ABSTRACT

A zoom lens includes a lens group having positive refractive power, a middle group having negative refractive power as a whole, a lens group having positive refractive power, a lens group having positive refractive power, a lens group having negative refractive power, and a rear group all of which are disposed in order from the object side to the image plane side, and has a specific optical characteristic expressed by a specific expression.

### CROSS-REFERENCE TO RELATED APPLICATIONS

This application is based on and claims the benefit of priority from Japanese Patent Application No. 2024-028943, filed on Feb. 28, 2024, the entire contents of which are incorporated herein by reference.

### BACKGROUND OF THE INVENTION

### Technical Field

The present invention relates to a zoom lens and an imaging apparatus.

### Related Art

Imaging apparatuses using solid-state image sensors such as digital still cameras and digital video cameras are widely used. Examples of the imaging apparatuses include a digital still camera, a digital video camera, a broadcast camera, a monitoring camera, a vehicle-mounted camera, and the like. Any imaging apparatuses have a high aperture ratio, there is a strong market demand for a zoom lens having a compact entire system, and high optical performance.

Under such circumstances, there is known a zoom lens having a large aperture ratio in which the lens group having positive, negative, positive, positive, and negative refractive powers are disposed in order from the object side, and the zoom ratio is 2.37 times and F value is 2.26 to 2.91 (see, for example, JP 2008-197774 A).

However, in the technique described in JP 2008-209712 A, since the positive combined refractive power from the first lens group to the fourth lens group is weak, it is difficult to miniaturize the zoom lens. In addition, since the negative refractive power of the second lens group is too strong with respect to the positive refractive power of the first lens group, it is difficult to reduce the lens diameter of the first lens group. As described above, in the related art, in order to solve these problems, there is room for examination of the power arrangement, the imaging magnification, the lens configuration, and the like of each lens group.

An object of an aspect of the present invention are to provide a high-performance zoom lens that is compact as a whole, and has various satisfactorily corrected aberrations, while having a high aperture ratio.

### SUMMARY OF THE INVENTION

In order to solve the above problem, a zoom lens according to an aspect of the present invention includes a lens group P1 having positive refractive power, a middle group including one or more lens groups and having negative refractive power as a whole, a lens group P2 having positive refractive power, a lens group P3 having positive refractive power, a lens group N having negative refractive power, and a rear group including one or more lens groups all of which are disposed in order from an object side to an image plane side, wherein the lens group P2 includes a lens component A, having negative refractive power, closest to an image plane, wherein the lens component A has an object side face having a concave surface facing an object, and wherein the zoom lens satisfies following Expression:

$$- 5. < fp 12 w / fw < - 0.3 \qquad ( 1 )$$

where
fp12w is a composite focal length of the zoom lens from the lens group P1 to the lens group P2 at a wide-angle end at a time of infinity focusing, and
fw is a focal length of the zoom lens at a wide-angle end at a time of infinity focusing.

In addition, in order to solve the above-described problem, an imaging apparatus according to an aspect of the present invention includes the zoom lens described above, and a solid-state image sensor that converts an optical image formed by the zoom lens into an electrical signal on an image plane side of the zoom lens.

According to an aspect of the present invention, it is possible to realize a high-performance zoom lens that is compact as a whole, and has various satisfactorily corrected aberrations, while having a high aperture ratio.

### BRIEF DESCRIPTION OF THE DRAWINGS

FIG. 1 is a diagram schematically illustrating an optical configuration of a zoom lens of Example 1 at a wide-angle end at a time of infinity focusing;

FIG. 2 is an aberration diagram, an astigmatism diagram, and a distortion diagram at a wide-angle end of the zoom lens of Example 1 at a time of infinity focusing;

FIG. 3 illustrates an aberration diagram, an astigmatism diagram, and a distortion diagram of the zoom lens of Example 1 in an intermediate focal point at a time of infinity focusing;

FIG. 4 is an aberration diagram, an astigmatism diagram, and a distortion diagram of the zoom lens of Example 1 at a telephoto end at a time of infinity focusing;

FIG. 5 is a diagram schematically illustrating an optical configuration of a zoom lens of Example 2 at a wide-angle end at a time of infinity focusing;

FIG. 6 illustrates an aberration diagram, an astigmatism diagram, and a distortion diagram of the zoom lens of Example 2 at a wide-angle end at a time of infinity focusing;

FIG. 7 is an aberration diagram, an astigmatism diagram, and a distortion diagram of the zoom lens of Example 2 at an intermediate focal point at a time of infinity focusing;

FIG. 8 is an aberration diagram, an astigmatism diagram, and a distortion diagram of the zoom lens of Example 2 at a telephoto end at a time of infinity focusing;

FIG. 9 is a diagram schematically illustrating an optical configuration of a zoom lens of Example 3 at a wide-angle end at a time of infinity focusing;

FIG. 10 illustrates an aberration diagram, an astigmatism diagram, and a distortion diagram of the zoom lens of Example 3 at a wide-angle end at a time of infinity focusing;

FIG. 11 illustrates an aberration diagram, an astigmatism diagram, and a distortion diagram of the zoom lens of Example 3 at an intermediate focal point at a time of infinity focusing;

FIG. 12 illustrates an aberration diagram, an astigmatism diagram, and a distortion diagram of the zoom lens of Example 3 at a telephoto end at a time of infinity focusing;

FIG. 13 is a diagram schematically illustrating an optical configuration of a zoom lens of Example 4 at a wide-angle end at a time of infinity focusing;

FIG. 14 illustrates an aberration diagram, an astigmatism diagram, and a distortion diagram of the zoom lens of Example 4 at a wide-angle end at a time of infinity focusing;

FIG. 15 illustrates an aberration diagram, an astigmatism diagram, and a distortion diagram of the zoom lens of Example 4 at an intermediate focal point at a time of infinity focusing;

FIG. 16 illustrates an aberration diagram, an astigmatism diagram, and a distortion diagram of the zoom lens of Example 4 at a telephoto end at a time of infinity focusing;

FIG. 17 is a diagram schematically illustrating an optical configuration of a zoom lens of Example 5 at a wide-angle end at a time of infinity focusing;

FIG. 18 illustrates an aberration diagram, an astigmatism diagram, and a distortion diagram of the zoom lens of Example 5 at a wide-angle end state at a time of infinity focusing;

FIG. 19 illustrates an aberration diagram, an astigmatism diagram, and a distortion diagram of the zoom lens of Example 5 at an intermediate focal point at a time of infinity focusing;

FIG. 20 illustrates an aberration diagram, an astigmatism diagram, and a distortion diagram of the zoom lens of Example 5 at a telephoto end at a time of infinity focusing;

FIG. 21 is a diagram schematically illustrating an optical configuration of a zoom lens of Example 6 at a wide-angle end at a time of infinity focusing;

FIG. 22 illustrates an aberration diagram, an astigmatism diagram, and a distortion diagram of the zoom lens of Example 6 at a wide-angle end at a time of infinity focusing;

FIG. 23 illustrates an aberration diagram, an astigmatism diagram, and a distortion diagram of the zoom lens of Example 6 at an intermediate focal point at a time of infinity focusing;

FIG. 24 illustrates an aberration diagram, an astigmatism diagram, and a distortion diagram of the zoom lens of Example 6 at a telephoto end at a time of infinity focusing; and

FIG. 25 is a diagram schematically illustrating an example of a configuration of an imaging apparatus according to an embodiment of the present invention.

### DESCRIPTION OF THE EMBODIMENTS

As an optical configuration of the zoom lens, for example, a positive lead configuration including a lens group having positive refractive power, the lens group being located closest to an object, is known. In a positive lead zoom lens, a lens group having strong negative refractive power is generally disposed as a second lens group disposed second from the object side. As described above, the configuration in which the second lens group has a large Variable magnification burden easily achieves high Variable magnification. Regarding the positive lead zoom lenses, there is a strong telephoto tendency, so that a total length of the optical system can be shortened as compared with the focal length.

Furthermore, in order to increase the diameter of the zoom lens, it is preferable to arrange a lens group having strong positive refractive power on the image plane side.

However, when a lens group having strong positive refractive power is disposed on the image plane side, it is difficult to obtain a zoom lens having a strong telephoto tendency, and it may be difficult to shorten the optical total length. Furthermore, when the refractive power of the second lens group having a large Variable magnification burden is too strong, various aberrations generated in the second lens group cannot be corrected well, and it may be difficult to obtain high optical performance. The present invention provides a technique for solving such a problem.

Hereinafter, embodiments of a zoom lens and an imaging apparatus according to the present invention will be described. More specifically, the present embodiment relates to an imaging apparatus and a zoom lens suitable for the imaging apparatus using a solid-state image sensor (CCD, CMOS, or the like) such as a digital still camera or a digital video camera. The zoom lens and the imaging apparatus to be described below is an aspect of the zoom lens and the imaging apparatus according to the present invention, and the zoom lens and the imaging apparatus according to the present invention are not limited to the following aspects.

Note that, in the present specification, the “zoom lens” is a generic term for a lens including the optical characteristics identified in the present invention, and means one or both of an optical system itself that exhibits the optical characteristics and an article including the optical system. Ahead of the zoom lens refers to an object side of the zoom lens, and behind the zoom lens refers to an image plane side of the zoom lens.

### 1. Zoom Lens

Hereinafter, an embodiment of the present invention will be described in detail.

### 1-1. Optical Configuration

The zoom lens according to the present embodiment includes a lens group P1 having positive refractive power, a middle group that includes one or more lens groups and has negative refractive power as a whole, a lens group P2 having positive refractive power, a lens group P3 having positive refractive power, a lens group N having negative refractive power, and a rear group that includes one or more lens groups all of which are disposed in order from the object side to the image plane side. Such a zoom lens is of the positive lead configuration, and is preferable from the viewpoint of high Variable magnification and miniaturization of zoom lenses.

In the present specification, the “lens group” means a set of one or more lenses that cooperate with each other in a variable magnification operation. The lenses in the lens group move while maintaining relative positional relationships in the variable magnification operation. The variable magnification operation is performed by changing intervals between lens groups, and intervals between lenses belonging to the same lens group do not change in the variable magnification operation.

The lens group P1 has the positive refractive power as a whole. A specific lens configuration of the lens group P1 is not particularly limited. For example, from the viewpoint of making the lens group P1 a lens group having strong refractive power, the lens group P1 may include two lenses having positive refractive power. When the lens group P1 has strong positive refractive power, it is possible to enhance the telephoto tendency at the telephoto end while achieving a high variable magnification ratio, which is preferable from the viewpoint of reducing the size of the zoom lens. The lens group P1 may include at least one lens having negative refractive power. This configuration facilitates correction of spherical aberration, chromatic aberration, and the like, and thus is preferable from the viewpoint of achieving a zoom lens having excellent optical performance.

The middle group has negative refractive power overall. The middle group may include one lens group or a set of two or more lens groups. All of the lens groups comprising the middle group may be groups having negative refractive power. When the middle group includes two or more lens groups having negative refractive power, it facilitates correction of the field curvature and the coma aberration caused with variable magnification, so that it is preferable from the viewpoint of achieving a zoom lens with excellent optical performance.

The lens group P2 has the positive refractive power as a whole. The lens group P2 preferably includes at least two lenses having positive refractive power and at least two lenses having negative refractive power. Divergent light enters the lens group P2. The fact that the lens group P2 has two or more lenses having positive refractive power is suitable for having a strong converging surface for the divergent light. It is also suitable for lens group P2 to have two or more lenses having negative refractive power from the viewpoint of expressing the action of correcting various aberrations generated by the converging action of the lenses having positive refractive power mentioned above. The number of lenses having positive refractive power and the number of lenses having negative refractive power can be appropriately determined from the above viewpoint, and may be the same or different. The position of these lenses in the lens group P2 may also be determined appropriately from the above perspective. The lens group P2 with the above configuration is preferable from the viewpoint of achieving a zoom lens that corrects spherical aberration and longitudinal chromatic aberration well, while maintaining a large aperture ratio.

The lens group P2 includes a lens component A, having negative refractive power, closest to the image plane. The lens component A has an object side face having a concave surface facing the object. Here, since the lens group P3 described later has positive refractive power, the combined refractive power of the lens group P2 and the lens group P3 is strong positive refractive power. Therefore, when the aperture ratio is large, spherical aberration in the under direction is likely to occur. Since the lens component A has an object side face having a concave surface facing the object, the on-axis pencil of light incident on the lens component A is a converged pencil of light. Therefore, spherical aberration in the over-direction can be generated on the object side face of the lens component A. In this way, it is preferable to arrange the lens component A in the lens group P2 from the viewpoint of favorably correcting the spherical aberration in the under direction.

In the present specification, the “lens component” refers to one single lens or a cemented lens in which a plurality of single lenses is integrated without an air distance. That is, even when the lens component has a plurality of optical surfaces, only the most object side face and the most image plane side face thereof are in contact with air, and the other surfaces are not in contact with air. The single lens may be either a spherical lens or an aspherical lens. In addition, in the present specification, the “aspherical lens” also includes a composite resin aspherical lens in which a composite resin film molded in an aspherical shape is attached to the surface.

The lens group P2 preferably includes a cemented lens having a cemented surface with a convex surface facing the object. This configuration is preferable from the viewpoint of correcting the spherical aberration in the under direction described above. From the same viewpoint, the cemented surface is more preferably a divergence surface. The lens component A described above may be a cemented lens, but is different from the cemented lens described herein. However, the cemented lens has the same effect as the lens component A.

The lens group P3 has the positive refractive power as a whole. The lens group P3 is a lens group that is disposed relatively rearward in the zoom lens and has the strongest positive refractive power in the optical system of the zoom lens. It is preferable that the lens group has positive refractive power from the viewpoint of increasing the diameter. The lens group P3 preferably includes at least one lens having negative refractive power and at least two lenses having positive refractive power. This configuration is preferable from the viewpoint of satisfactorily correcting spherical aberration, coma aberration, and chromatic aberration.

The lens group N has the negative refractive power as a whole. A specific lens configuration of the lens group N is not particularly limited. For example, the lens group N may include only one lens having negative refractive power, or may include a lens having positive refractive power and a lens having negative refractive power. With the configuration including the lens having positive refractive power and the lens having negative refractive power, it is easy to obtain a high-performance zoom lens in which various aberrations such as spherical aberration and chromatic aberration are satisfactorily corrected over the entire object distance.

The rear group is a group including one or more lens groups disposed closer to the image plane than the lens group N. A specific configuration of the rear group is not particularly limited. The rear group may include one lens group from the viewpoint of shortening the zoom lens optical system. On the other hand, the rear group may be a set of two or more lens groups from the viewpoint of favorably correcting the field curvature in the entire zoom region.

The rear group is disposed from the viewpoint of enhancing the optical characteristics of the zoom lens, and the arrangement of the lens in the rear group may be appropriately determined from the viewpoint of improving desired characteristics. For example, the rear group preferably includes one convex lens and one concave lens from the viewpoint of favorably correcting the field curvature. Furthermore, from the above viewpoint, the rear group more preferably includes one convex lens and two concave lenses.

The overall refractive power of the rear group is not particularly limited. The rear group may have positive refractive power as a whole. The configuration in which the rear group has positive refractive power is preferable from the viewpoint of reducing the F value of the zoom lens. On the other hand, the rear group may have negative refractive power as a whole. The configuration in which the rear group has negative refractive power is preferable from the viewpoint of shortening the optical total length at the telephoto end because it is easy to obtain a zoom lens having a stronger telephoto tendency at the telephoto end.

The aperture stop is preferably disposed adjacent to the lens group P2 closer to the object or inside the lens group P2. The configuration in which the aperture stop is disposed adjacent to the lens group P2 closer to the object enables the entrance pupil position to be disposed closer to the object, as compared with the case where the aperture stop is disposed inside the lens group P2. Therefore, it is preferable from the viewpoint of easily reducing a diameter of the peripheral pencil of light passing through the lens group P1 at the telephoto end and easily reducing the front lens diameter.

### 1-2. Operation

### 1-2-1. Variable Magnification

The zoom lens varies the magnification by changing an air distance on an optical axis between adjacent lens groups at the time of variable magnification from a wide-angle end to a telephoto end.

The lens group P1 preferably moves toward the object at the time of variable magnification from the wide-angle end to the telephoto end. Such movement of the lens group P1 is preferable from the viewpoint of realizing a compact zoom lens having a short optical total length at a wide-angle end.

The movement of each lens group constituting the middle group is not particularly limited. For example, at the time of variable magnification from the wide-angle end to the telephoto end, each lens group constituting the middle group may move toward the image plane. When the middle group moves in this way, it is easy to suppress the movement distance of the lens group P1, which is preferable for realizing a zoom lens having a short optical total length at the telephoto end.

At the time of variable magnification from the wide-angle end to the telephoto end, it is preferable that the lens group P2, the lens group P3, and the lens group N move toward the object. By moving the lens group P2, the lens group P3, and the lens group N in this way, it is easy to increase the combined variable magnification ratio from the lens group P2 to the lens group N, and variable magnification by each lens group is suitably performed, which is preferable from the viewpoint of achieving both high Variable magnification and high performance.

At the time of variable magnification from the wide-angle end to the telephoto end, the rear group may be fixed or may move toward the object. A configuration in which the rear group is fixed at the time of variable magnification is preferable from the viewpoint of simplification of the cam structure and prevention of entry of dust into the lens barrel. A configuration in which the rear group moves toward the object at the time of variable magnification from the wide-angle end to the telephoto end is preferable from the viewpoint of satisfactorily correcting the field curvature in the entire zoom region.

### 1-2-2. Focusing

In the zoom lens, the lens group N preferably moves along the optical axis at the time of focusing. Here, lens group N is disposed closer to the image plane than the lens group P3. Since the pencil of light converged by the lens group P3 is incident on the lens group N, the lens group N has a small lens diameter and is easily configured to be lightweight. Therefore, in a case where the lens group N is a focusing group, high-speed autofocus (AF) can be realized, and the load of the focus drive system can be easily reduced. Furthermore, the lens group N is disposed on the rear side of the zoom lens. Therefore, it is preferable to use lens group N as the focusing group from the viewpoint of suppressing the variation in the angle of view accompanying the movement of the focusing group. With this configuration, it is easy to realize a zoom lens suitable for moving image capturing or the like using the tracking AF function not only when the contrast AF method is used but also when the image plane phase difference AF method is used. Since the lateral magnification of the lens group N takes a value larger than 1, the lens group F moves toward the image plane when focusing from infinity to a short distance object.

In the zoom lens, not only the lens group N but also a lens group different from the lens group N or part of the lens group may be moved at the time of focusing. This configuration is a so-called floating focus system, and adopting this configuration facilitates aberration correction in a short distance object, which is preferable from the viewpoint of obtaining a high-performance zoom lens. On the other hand, in the zoom lens, it is preferable that only the lens group N move at the time of focusing. This configuration is preferable from the viewpoint of simplifying the focus driving mechanism and realizing downsizing and weight reduction of the zoom lens.

### 1-3. Expressions

The zoom lens preferably employs the above-described configuration and satisfies at least one or more of the following expressions.

$$1 - 3 - 1. \qquad Expression ( 1 )$$

$$- 5. < fp 12 w / fw < - 0.3 \qquad ( 1 )$$

where
fp12w is a composite focal length of the zoom lens from the lens group P1 to the lens group P2 at a wide-angle end at a time of infinity focusing, and
fw is a focal length of the zoom lens at a wide-angle end at a time of infinity focusing.

Expression (1) is an expression for appropriately defining the ratio between the composite focal length of the zoom lens from the lens group P1 to the lens group P2 at the wide-angle end and the focal length of the zoom lens at the wide-angle end. Satisfying Expression (1) is preferable from the viewpoint of achieving a bright zoom lens with a F value because a lens group having strong positive refractive power can be easily disposed behind the optical system of the zoom lens while it is the positive lead zoom lens.

When fp12w/fw is −5.0 or less, the negative composite focal length from the lens group P1 to the lens group P2 at the wide-angle end is too weak, and it may be difficult to dispose strong positive refractive power behind the optical system of the zoom lens. On the other hand, when fp12w/fw is −0.3 or more, the negative composite focal length from the lens group P1 to the lens group P2 at the wide-angle end may be too strong.

From the viewpoint of satisfactorily correcting various aberrations and obtaining high optical performance, fp12w/fw is preferably smaller than −0.5, more preferably smaller than −0.7, still more preferably smaller than −0.9, still more preferably smaller than −1.1, still more preferably smaller than −1.3, and still more preferably smaller than −1.5. In addition, from the viewpoint of setting the refractive power before and after the zoom lens in a suitable range and obtaining a bright zoom lens with an F value, fp12w/fw is preferably larger than −4.5, more preferably larger than −4.0, still more preferably larger than −3.7, preferably larger than −3.3, more preferably larger than −3.1, still more preferably larger than −2.9, still more preferably larger than −2.7, still more preferably larger than −2.5, still more preferably larger than −2.3, and still more preferably larger than −2.1.

It is preferable to satisfy Expression (1) from the viewpoint of achieving a wide angle of the zoom lens. Note that the wide angle of the zoom lens in the present embodiment can be expressed as, for example, that ωw is larger than) 30° (ωw>30°, where ωw is a half angle of view of the maximum off-axis main beam of the zoom lens at the wide-angle end.

$$1 - 3 - 2. \qquad Expression ( 2 )$$

$$0.5 < bfw / Yw < 1.5 \qquad ( 2 )$$

where
bfw is a back focus of the zoom lens at a wide-angle end at a time of infinity focusing, and
Yw is a maximum image height of the zoom lens at a wide-angle end at a time of infinity focusing.

Expression (2) is an expression for appropriately defining the ratio between the back focus of the zoom lens at the wide-angle end and the maximum image height at the wide-angle end. Satisfying Expression (2) is preferable because the back focus of the zoom lens at the wide-angle end can be shortened, and the overall length of the optical system can be easily reduced.

When bfw/Yw is 0.5 or less, the back focus of the zoom lens at the wide-angle end is too short, and the emission angle from the zoom lens may be too large. Here, on the image plane of the image sensor, a condenser lens such as an on-chip microlens for efficiently receiving an incident angle is provided in each pixel, and a light receiving angle of the on-chip microlens or the like is limited within a predetermined range. Therefore, when the emission angle from the zoom lens increases and the inclination angle of the incident angle on the image plane with respect to the optical axis is too large, peripheral light reduction (shading) due to mismatch with the on-chip microlens may increase. On the other hand, when bfw/Yw is 1.5 or more, the back focus of the zoom lens at the wide-angle end may be excessively long.

From the viewpoint of shortening the back focus and reducing the total length of the optical system of the zoom lens, bfw/Yw is preferably smaller than 1.35, more preferably smaller than 1.3, still more preferably smaller than 1.25, preferably smaller than 1.2, still more preferably smaller than 1.15, and still more preferably smaller than 1.1. In addition, from the viewpoint of setting the emission angle of the zoom lens in a suitable range and suppressing peripheral light reduction due to a mismatch with the on-chip microlens, bfw/Yw is preferably larger than 0.55, more preferably larger than 0.60, still more preferably larger than 0.65, still more preferably larger than 0.70, still more preferably larger than 0.75, and still more preferably larger than 0.80.

$$1 - 3 - 3. \qquad Expression ( 3 )$$

$$- 5. < ( Rf + Rb ) / ( Rf - Rb ) < - 0.1 \qquad ( 3 )$$

where
Rf is a radius of curvature of the object-side lens surface of the lens component A, and
Rb is a radius of curvature of the image plane-side lens surface of the lens component A.

Expression (3) is an expression related to the shape (shape factor) of the lens component A. Satisfying equation (3) is preferable because spherical aberration can be easily corrected in the entire zoom region.

When (Rf+Rb)/(Rf−Rb) is −5.0 or less, the divergence action of the lens component A may be too small. On the other hand, when (Rf+Rb)/(Rf−Rb) is −0.1 or more, the divergence action of the lens component A may be too large.

From the viewpoint of setting the divergence action of the lens component A in a suitable range and satisfactorily correcting the spherical aberration in the zoom region, (Rf+Rb)/(Rf−Rb) is preferably smaller than −0.15, more preferably smaller than −0.2, still more preferably smaller than −0.25, still more preferably smaller than −0.3, still more preferably smaller than −0.35, and still more preferably smaller than −0.4. In addition, from the viewpoint of setting the divergence action of the lens component A in a suitable range and satisfactorily correcting the spherical aberration in the entire zoom region, (Rf+Rb)/(Rf−Rb) is preferably larger than −4.5, more preferably larger than −4.0, still more preferably larger than −3.5, still more preferably larger than −3.0, still more preferably larger than −2.5, and still more preferably larger than −2.0.

$$1 - 3 - 4. \qquad Expression ( 4 )$$

$$- 1.3 < fA / fp 2 < - 0.001 \qquad ( 4 )$$

where
fA is a focal length of the lens component A, and
fp2 is a focal length of the lens group P2.

Expression (4) is an expression for appropriately setting the ratio between the focal length of the lens component A and the focal length of the lens group P2. Satisfying the expression (4) is preferable from the viewpoint of achieving both the wide angle of the zoom lens and the optical performance in a well-balanced manner.

When fA/fp2 is −1.3 or less, the negative refractive power of the lens component A is too small with respect to the focal length of the lens group P2, and it may be difficult to satisfactorily correct the spherical aberration generated in the lens group P2. On the other hand, when fA/fp2 is −0.001 or more, the negative refractive power of the lens component A is too large with respect to the focal length of the lens group P2, and the principal point position of the lens group P2 is located closer to the object. Therefore, the distance between principal points of the lens group P2 and the lens group having the negative refractive power disposed closer to the object than the lens group P2 may be shortened.

From the viewpoint of setting the distance between principal points in a suitable range, making it easy to widen the angle of view of the zoom lens, and obtaining a desired angle of view at the wide-angle end, fA/fp2 is preferably smaller than −0.08, more preferably smaller than −0.12, still more preferably smaller than −0.15, and still more preferably smaller than −0.18. In addition, from the viewpoint of satisfactorily correcting spherical aberration occurring in the lens group P2 and realizing a zoom lens with high optical performance with a small number of lenses, fA/fp2 is preferably larger than −1.1, more preferably larger than −1.0, still more preferably larger than −0.9, still more preferably larger than −0.8, and still more preferably larger than −0.75.

$$1 - 3 - 5. Expression ( 5 )$$

$$0.0001 < fp 3 / fp 2 < 0 \text{.45} \qquad ( 5 )$$

where
fp3 is a focal length of the lens group P3, and
fp2 is a focal length of the lens group P2.

Expression (5) is an expression for appropriately setting the ratio between the focal length of the lens group P3 and the focal length of the lens group P2. Satisfying the expression (5) is preferable because it is easy to achieve both a large diameter and an increase in performance of the zoom lens.

When fp3/fp2 is 0.001 or less, since the positive refractive power of the lens group P3 is too large with respect to the focal length of the lens group P2, the height of the on-axis pencil of light passing through the lens group P3 may be too high. On the other hand, when fp3/fp2 is 0.45 or more, the positive refractive power of the lens group P3 is small with respect to the focal length of the lens group P2, and the positive refractive power of the lens group P3 is too large, which may affect various aberrations such as spherical aberration and chromatic aberration generated in the lens group P2. In this case, in order to obtain good imaging performance while maintaining a desired F value of the lens of the lens group P2, the number of lenses of the lens group P2 may be increased.

From the viewpoint of satisfactorily correcting various aberrations generated in the lens group P2 and reducing the number of lenses to realize miniaturization of the entire length, fp3/fp2 is preferably smaller than 0.40, more preferably smaller than 0.38, still more preferably smaller than 0.35, and still more preferably smaller than 0.32. In addition, from the viewpoint of setting each refractive power of the lens group P3 and the lens group P2 in a suitable range and favorably correcting the spherical aberration at the telephoto end, fp3/fp2 is preferably larger than 0.03, more preferably larger than 0.05, still more preferably larger than 0.08, still more preferably larger than 0.10, and still more preferably larger than 0.12.

$$1 - 3 - 6. Expression ( 6 )$$

$$0. 4 < fp 3 / fw < 1.3 \qquad ( 6 )$$

where
fp3 is a focal length of the lens group P3, and
fw is a focal length of the zoom lens at a wide-angle end at a time of infinity focusing.

Expression (6) is an expression for appropriately setting the ratio between the focal length of the lens group P3 and the focal length of the optical system of the zoom lens at the wide-angle end. Satisfying formula (6) is preferable because it is easy to achieve both a large diameter and a small size of the zoom lens. In addition, when ωw>30° is satisfied, the effect obtained by satisfying Expression (6) is the largest.

When fp3/fw is 0.4 or less, the positive refractive power of the lens group P3 is large with respect to the focal length of the optical system of the zoom lens at the wide-angle end, and the focal length of the lens group P3 disposed closer to the object than the lens group N may be too short. On the other hand, when fp3/fw is 1.3 or more, it may be difficult to increase the diameter at the wide-angle end, and reduce the overall length.

From the viewpoint of increasing the diameter at the wide-angle end and reducing the overall length, fp3/fw is preferably smaller than 1.2, more preferably smaller than 1.15, still more preferably smaller than 1.1, still more preferably smaller than 1.05, and still more preferably smaller than 1.0. In addition, from the viewpoint of setting the focal length of the lens group P3 in a suitable range and favorably correcting astigmatism and coma aberration at a short distance, fp3/fw is preferably larger than 0.5, more preferably larger than 0.6, still more preferably larger than 0.7, and still more preferably larger than 0.8.

$$1 - 3 - 7. Expression ( 7 )$$

$$15 < vd < 40 \qquad ( 7 )$$

where
vd is an Abbe number of a lens, of the lens group P2, having positive refractive power, the lens being closest to the object, with respect to d Line.

Expression (7) is an expression for appropriately setting the Abbe number of the lens, of the lens group P2, having positive refractive power, the lens being disposed closest to the object, with respect to d Line. Satisfying equation (7) is preferable because the longitudinal chromatic aberration can be easily corrected satisfactorily in the entire zoom region. Here, the lens having the positive refractive power included in the lens group having the positive refractive power corrects the chromatic aberration by using the material with the low dispersion, but the lens group P2 of the zoom lens has a large divergence action by the divergence surface, and the longitudinal chromatic aberration on the short wavelength side tends to be excessive (excessive correction). Therefore, when the lens, of the lens group P2, having the positive refractive power, the lens being disposed closest to the object, is made of a high dispersion material that satisfies Expression (7), favorable chromatic aberration correction is easy.

When vd is 15 or less, longitudinal chromatic aberration on the short wavelength side tends to be under (insufficient correction) in some cases. On the other hand, when vd is 40 or more, the longitudinal chromatic aberration on the short wavelength side tends to be excessive, and the correction is difficult.

From the viewpoint of suitably correcting the longitudinal chromatic aberration, vd is preferably smaller than 35, more preferably smaller than 32, still more preferably smaller than 30, and still more preferably smaller than 28. From the viewpoint of suitably correcting the longitudinal chromatic aberration, vd is preferably larger than 18, and more preferably larger than 20.

$$1 - 3 - 8. Expression ( 8 )$$

$$2. 5 < fp 1 / fw < 1 0. \qquad ( 8 )$$

where
fp1 is a focal length of the lens group P1, and
fw is a focal length of the zoom lens at a wide-angle end at a time of infinity focusing.

Expression (8) is an expression for appropriately setting the ratio between the focal length of the lens group P1 and the focal length of the optical system of the zoom lens at the wide-angle end. When Equation (8) is satisfied, it is easy to achieve both the wide angle and the small size. In addition, when ωw>30° is satisfied, the effect by satisfying Expression (8) is the largest.

When fp1/fw is 2.5 or less, the refractive power of the lens group P1 is too strong with respect to the focal length of the optical system of the zoom lens at the wide-angle end, and it may be difficult to correct the negative field curvature. On the other hand, when fp1/fw is 10.0 or more, the refractive power of the lens group P1 is weak with respect to the focal length of the optical system of the zoom lens at the wide-angle end, and the movement distance of the lens group P1 may be too long.

From the viewpoint of shortening the movement distance of the lens group P1, simplifying the cam structure, and realizing the miniaturization of the lens barrel, fp1/fw is preferably smaller than 8.0, more preferably smaller than 7.0, still more preferably smaller than 6.0, still more preferably smaller than 5.5, and still more preferably smaller than 5.0. In addition, from the viewpoint of appropriately correcting the negative image plane distortion and realizing the wide angle of the zoom lens, fp1/fw is preferably larger than 3.0, more preferably larger than 3.5, and still more preferably larger than 3.7.

$$1 - 3 - 9. Expression ( 9 )$$

$$0. 7 < FNOp 1 \_ 3 < 1.9 \qquad ( 9 )$$

where

FNOp1_3 is a minimum value of an open F value in a zoom region from the lens group P1 to the lens group P3.

Expression (9) is an expression for appropriately setting the minimum value of the open F value in the zoom region from the lens group P1 to the lens group P3. By satisfying Expression (9), it is easy to secure desired brightness of the zoom lens.

When FNOp1_3 is 0.7 or less, the open F value from the lens group P1 to the lens group P3 is too small, and it may be difficult to satisfactorily correct various aberrations. On the other hand, when FNOp1_3 is 1.9 or more, it may be difficult to ensure desired brightness of the zoom lens. In this case, in order to obtain desired brightness, it may be necessary to give strong positive refractive power to the rear group, and the telephoto tendency tends to be weakened.

From the viewpoint of setting the telephoto ratio in a suitable range and achieving shortening of the entire length, FNOp1_3 is preferably smaller than 1.7, more preferably smaller than 1.6, still more preferably smaller than 1.5, still more preferably smaller than 1.45, and still more preferably smaller than 1.4. In addition, from the viewpoint of favorably correcting various aberrations, FNOp1_3 is preferably larger than 0.8, more preferably larger than 0.9, and still more preferably larger than 1.0.

$$1 - 3 - 10. Expression ( 10 )$$

$$0. 3 < β p 2 w < 5. \qquad ( 10 )$$

where
βp2w is a lateral magnification of the lens group P2 at a wide-angle end at a time of infinity focusing.

Expression (10) is an expression for appropriately setting the lateral magnification of the lens group P2 at the wide-angle end. When Expression (10) is satisfied, it is easy to achieve both miniaturization and high performance of the zoom lens while securing a back focus suitable for the interchangeable lens.

When βp2w is 0.3 or less, the pencil of light emitted from the lens group P2 is strong divergent light, and the back focus may be long. On the other hand, when βp2w is 5.0 or more, it is easy to miniaturize the entire length of the optical system, but the divergence action of the lens group P2 may be too small.

From the viewpoint of favorably correcting the spherical aberration generated in the lens group P2, βp2w is preferably smaller than 4.7, more preferably smaller than 4.5, still more preferably smaller than 4.2, still more preferably smaller than 4.0, and still more preferably smaller than 3.8. In addition, from the viewpoint of shortening the back focus and reducing the overall length of the optical system, βp2w is preferably larger than 0.5, more preferably larger than 0.6, and still more preferably larger than 0.7.

$$1 - 3 - 11. Expression ( 11 )$$

$$4. 0 < Tw / Yw < 8.5 \qquad ( 11 )$$

where
Tw is an optical total length of the zoom lens at a wide-angle end at a time of infinity focusing, and
Yw is a maximum image height of the zoom lens at a wide-angle end at a time of infinity focusing.

Expression (11) is an expression for appropriately setting the total length of the optical system of the zoom lens at the wide-angle end with respect to the maximum image height at the wide-angle end. When Expression (11) is satisfied, it is easy to achieve both downsizing of the entire length of the optical system at the wide-angle end and high performance.

When Tw/Yw is 4.0 or less, the optical total length of the zoom lens at the wide-angle end may be excessively short with respect to the maximum image height at the wide-angle end. On the other hand, when Tw/Yw is 8.5 or more, the optical total length of the zoom lens at the wide-angle end may be excessively long with respect to the maximum image height at the wide-angle end.

From the viewpoint of setting the entire length of the optical system with respect to the maximum image height in a suitable range and realizing miniaturization, Tw/Yw is preferably smaller than 8.2, more preferably smaller than 8.0, and still more preferably smaller than 7.8. In addition, from the viewpoint of setting the entire length of the optical system with respect to the maximum image height in a suitable range and achieving high optical performance, Tw/Yw is preferably larger than 4.5, more preferably larger than 5.0, still more preferably larger than 5.5, and still more preferably larger than 5.8.

### 2. Imaging Apparatus

Next, the imaging apparatus according to an embodiment of the present invention will be described. The imaging apparatus includes the zoom lens according to the present embodiment described above and an image sensor that is provided in the zoom lens closer to the image plane and converts an optical image formed by the zoom lens into an electrical signal.

Here, the image sensor is not limited, and a solid-state image sensor such as a charge coupled device (CCD) sensor or a complementary metal oxide semiconductor (CMOS) sensor can be used as the image sensor, and a silver salt film, an infrared cut filter (IRCF), or the like can also be used. The imaging apparatus according to the present embodiment is suitable for an imaging apparatus using the above-described solid-state image sensor, such as a digital camera and a video camera. In addition, the imaging apparatus may be a lens fixed type imaging apparatus in which a lens is fixed to a housing or may be a lens interchangeable type imaging apparatus such as a single lens reflex camera and a mirrorless camera. Specifically, the zoom lens according to the present embodiment can ensure back focus suitable for the interchangeable lens system. Therefore, the present invention is suitable for an imaging apparatus such as a single lens reflex camera including an optical finder, a phase difference sensor, a reflex mirror for branching light to them, and the like.

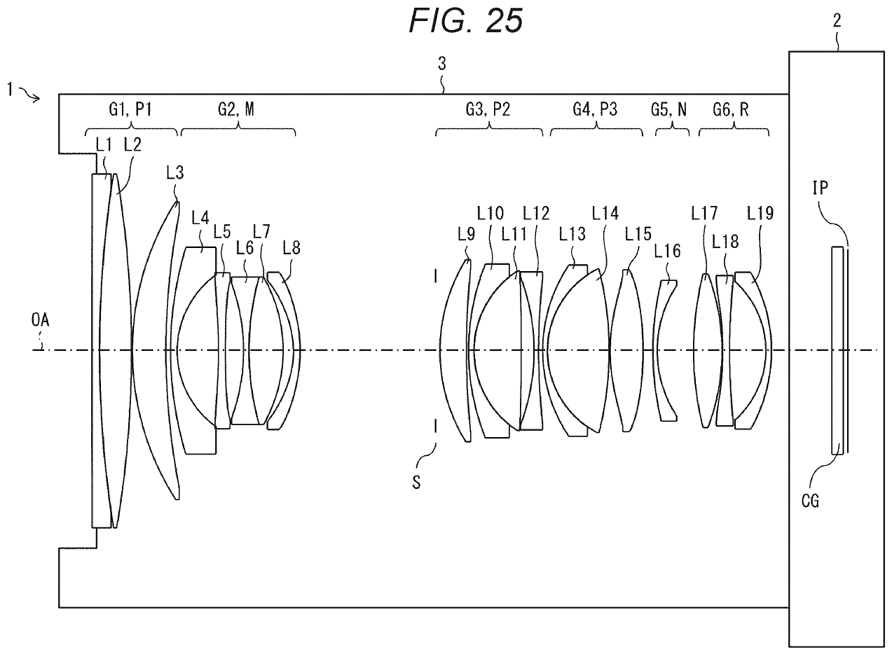

FIG. 25 is a diagram schematically illustrating an example of a configuration of the imaging apparatus according to the present embodiment. As illustrated in FIG. 25, a mirrorless camera 1 includes a main body 2 and a lens barrel 3 detachably provided to the main body 2. The lens barrel 3 includes a zoom lens therein, and the lens barrel 3 and the zoom lens constitute the zoom lens. The mirrorless camera 1 is an aspect of the imaging apparatus.

The zoom lens includes a first lens group G1 to a sixth lens group G6. The zoom lens is configured to satisfy, for example, Expression (1) described above. A stop S is disposed closer to the object than the lens L9 included in second lens group G3.

The first lens group G1 has positive refractive power as a whole, and includes lenses L1 to L3. The second lens G2 has negative refractive power as a whole, and includes lenses L4 to L8. The third lens G3 has positive refractive power as a whole, and includes lenses L9 to L12. The fourth lens G4 has positive refractive power as a whole, and includes lenses L13 to L15. The fifth lens group G5 has negative refractive power as a whole, and includes lens L16. The sixth lens group G6 has negative refractive power as a whole, and includes lenses L17 to L19.

The main body 2 includes a CCD sensor IP as an image sensor and a cover glass CG. The CCD sensor I is disposed in the main body 2 at a position where the optical axis OA of the zoom lens in the lens barrel 3 attached to the main body 2 is the central axis. The main body 2 may have a parallel flat plate having no substantial refractive power such as an infrared cut filter (IRCF) instead of the cover glass CG.

Since the mirrorless camera 1 includes a zoom lens, both high optical performance and miniaturization of a product can be achieved.

The present invention is not limited to the above-described embodiments, but can be modified in various ways within the scope of the claims. Embodiments obtained by appropriately combining technical means disclosed in different embodiments are also included in the technical scope of the present invention.

### SUMMARY

A zoom lens according to a first aspect of the present invention includes a lens group P1 having positive refractive power, a middle group including one or more lens groups and having negative refractive power as a whole, a lens group P2 having positive refractive power, a lens group P3 having positive refractive power, a lens group N having negative refractive power, and a rear group including one or more lens groups all of which are disposed in order from an object side to an image plane side, wherein the lens group P2 includes a lens component A, having negative refractive power, closest to an image plane, wherein the lens component A has an object side face having a concave surface facing an object, and wherein the zoom lens satisfies following Expression:

$$- 5.0 < fp 12 w / fw < - 0.3 \qquad ( 1 )$$

where
fp12w is a composite focal length of the zoom lens from the lens group P1 to the lens group P2 at a wide-angle end at a time of infinity focusing, and
fw is a focal length of the zoom lens at a wide-angle end at a time of infinity focusing.

The zoom lens according to a second aspect of the present invention according to the first aspect satisfies following Expression:

$$0. 5 < bfw / Yw < 1.5 \qquad ( 2 )$$

where
bfw is a back focus of the zoom lens at a wide-angle end at a time of infinity focusing, and

Yw is a maximum image height of the zoom lens at a wide-angle end at a time of infinity focusing.

The zoom lens according to a third aspect of the present invention satisfies following Expression according to the first or second aspect:

$$- 5.0 < ( R f + Rb ) / ( Rf - Rb ) < - 0.1 \qquad ( 3 )$$

where
Rf is a radius of curvature of the object-side lens surface of the lens component A, and
Rb is a radius of curvature of the image plane side lens surface of the lens component A.

The zoom lens according to a fourth aspect of the present invention satisfies following Expression according to any one of the first to third aspects:

$$- 1.3 < fA / fp 2 < - 0.0 \; 01 \qquad ( 4 )$$

where
fA is a focal length of the lens component A, and
fp2 is a focal length of the lens group P2.

The zoom lens according to a fifth aspect of according to any one of the first to fourth aspects:

$$0.001 < fp 3 / fp 2 < 0 \text{.45} \qquad ( 5 )$$

where
fp3 is a focal length of the lens group P3, and
fp2 is a focal length of the lens group P2.

The zoom lens according to a sixth aspect of the present invention satisfies following Expression according to any one of the first to fifth aspects:

$$0. 4 < fp 3 / fw < 1.3 \qquad ( 6 )$$

where
fp3 is a focal length of the lens group P3

The zoom lens according to a seventh aspect of the present invention satisfies following Expression according to any one of the first to sixth aspects:

$$15 < v d < 40 \qquad ( 7 )$$

where
vd is an Abbe number of a lens, of the lens group P2, having positive refractive power, the lens being closest to the object, with respect to d Line.

The zoom lens according to an eighth aspect of the present invention satisfies following Expression according to any one of the first to seventh aspects:

$$2. 5 < fp 1 / fw < 1 0. \qquad ( 8 )$$

where
fp1 is a focal length of the lens group P1.

The zoom lens according to a ninth aspect of according to any one of the first to eighth aspects:

$$0.7 < FNOp1\_ 3 < 1.9 \qquad ( 9 )$$

where
FNOp1_3 is a minimum value of an open F value in an entire zoom region from the lens group P1 to the lens group P3.

The zoom lens according to a tenth aspect of the present invention following Expression according to any one of the first to ninth aspects satisfies:

$$0.3 < β p 2 w < 5. \qquad ( 10 )$$

where
βp2w is a lateral magnification of the lens group P2 at a wide-angle end at a time of infinity focusing.

The zoom lens according to an eleventh aspect of the present invention satisfies following Expression according to any one of the first to tenth aspects:

$$4. < Tw / Yw < 8.5 \qquad ( 11 )$$

where
Tw is an optical total length of the zoom lens at a wide-angle end at a time of infinity focusing.

In the zoom lens according to a twelfth aspect of the present invention, in any one of the first to eleventh aspects, the lens group P2 includes a cemented lens having a cemented surface with a convex surface facing the object.

In the zoom lens according to a thirteenth aspect of the present invention, in any one of the first to twelfth aspects, the lens group P2 includes at least two lens having the positive refractive power and at least two lens having the negative refractive power.

In the zoom lens according to a fourteenth aspect of the present invention, in any one of the first to thirteenth aspects, the lens group N moves on an optical axis at the time of focusing.

The imaging apparatus according to a fifteenth aspect of the present invention includes the zoom lens according to any one of the first to fourteenth aspects, and the image sensor that converts an optical image formed by the zoom lens on the image plane side of the zoom lens into an electrical signal.

### EXAMPLES

An example of the present invention will be described below. Unless otherwise specified in the following tables, units of lengths are all “mm”, units of angles of view are all “°”, and “E+a” indicates “×10^{a}”.

### Example 1

### (1) Configuration of Optical System

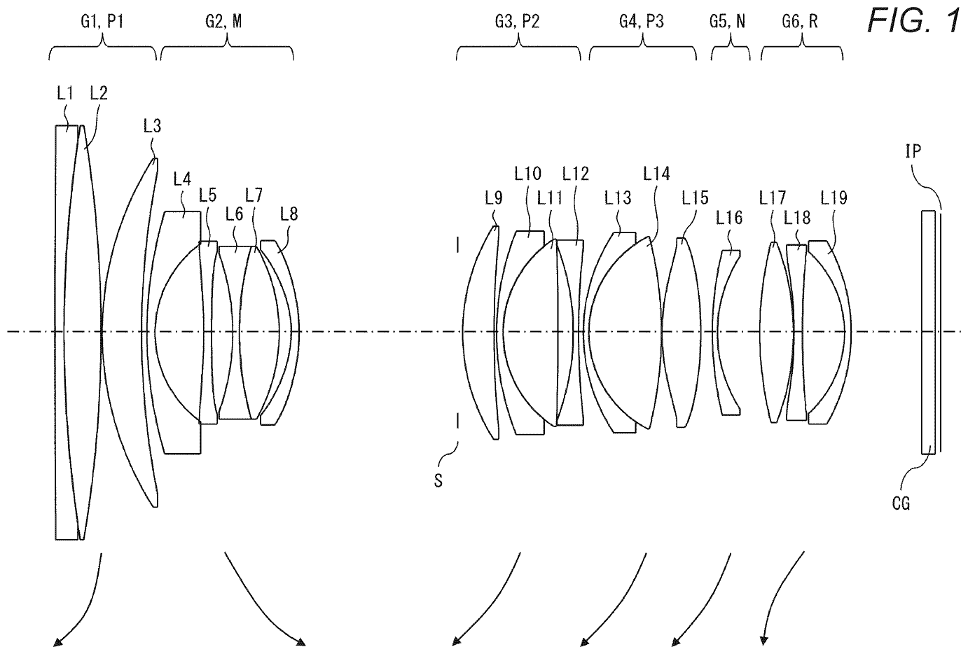

FIG. 1 is a diagram schematically illustrating an optical configuration of the zoom lens of Example 1 at a wide-angle end at a time of infinity focusing. The zoom lens according to Example 1 includes, in order from the object side, a first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having negative refractive power.

The first lens group G1 includes, in order from the object side, a cemented lens of a meniscus lens L1 and a biconvex lens L2 having negative refractive power with a convex surface facing the object, and a meniscus lens L3 having positive refractive power with a convex surface facing the object.

The second lens group G2 includes, in order from the object side, a meniscus lens L4 having negative refractive power with a convex surface facing the object, a biconcave lens L5, a cemented lenses of a biconcave lens L6 and a biconvex lens L7, and a meniscus lens L8 having negative refractive power with a concave surface facing the object. The biconcave lens L5 is a glass molded aspherical lens both surfaces of which have an aspherical shape. The meniscus lens L8 having negative refractive power is a glass molded aspherical lens both surfaces of which have an aspherical shape.

The third lens group G3 includes, in order from the object side, a meniscus lens L9 having positive refractive power with a convex surface facing the object, a cemented lens of a meniscus lens L10 and a biconvex lens L11 having negative refractive power with a convex surface facing the object, and a biconcave lens L12.

The fourth lens group G4 includes, in order from the object side, a cemented lens of a meniscus lens L13 and a biconvex lens L14 having negative refractive power with a convex surface facing the object, and a biconvex lens L15. The biconvex lens L15 is a glass molded aspherical lens both surfaces of which have an aspherical shape.

The fifth lens group G5 includes a meniscus lens L16 having negative refractive power with a convex surface facing the object.

The sixth lens group G6 includes a biconvex lens L17, a biconcave lens L18, and a meniscus lens L19 having negative refractive power with a concave surface facing the object. The biconcave lens L18 is a glass molded aspherical lens both surfaces of which have an aspherical shape.

The aperture stop S is disposed adjacent to the third lens group G3 closer to the object.

“CG” is a cover glass, and “IP” is an image plane. These are the same in the drawings schematically illustrating the optical configuration illustrated in another example, and thus the description thereof will be omitted below.

The first lens group G1 corresponds to the lens group P1 described above. The second lens group G2 corresponds to the middle group described above. The third lens group G3 corresponds to the lens group P2 described above. The fourth lens group G4 corresponds to the lens group P3 described above. The fifth lens group G5 corresponds to the lens group N described above. The sixth lens group G6 corresponds to the rear group described above. The biconcave lens L12 corresponds to the lens component A described above.

Note that, in FIG. 1, the middle group is denoted by M, and the rear group is denoted by R, and this point is the same in a schematic diagram illustrating an optical configuration of another example. Hereinafter, a configuration corresponding to the above-described middle group may be referred to as a middle group M, and a configuration corresponding to the above-described rear group may be referred to as a rear group R.

In Example 1, the zoom lens varies the magnification by changing the air distance on the optical axis between the adjacent lens groups. This point is the same in another example, and thus the description thereof will be omitted below.

Arrows in FIG. 1 indicate a movement direction and a movement manner of each lens group of the zoom lens of Example 1 at the time of variable magnification from the wide-angle end to the telephoto end. At the time of variable magnification from the wide-angle end to the telephoto end, the first lens group G1 moves toward the object, the second lens group G2 moves toward the image plane, the third lens group G3 moves toward the object, the fourth lens group G4 moves toward the object, the fifth lens group G5 moves toward the object, and the sixth lens group G6 moves toward the object.

Focusing from an infinite-distance object to a short distance object is done by the fifth lens group G5 moving toward the image plane.

### (2) Numerical-Value Examples

Next, numerical-value examples to which specific numerical values of the zoom lens are applied will be described. Table 1 shows data of each surface included in the zoom lens of Example 1.

In Table 1, the surface number indicates the order of the lens surface counted from the object side, “r” indicates a radius of curvature, “d” indicates a surface interval, nd indicates a refractive index of d Line (λ=587.56 nm), and vd indicates an Abbe number based on d Line (λ=587.56 nm). In addition, “S” attached to the surface number in the table indicates an aperture stop, and “ASPH” indicates an aspherical lens. “^{∞}” means infinity. A display such as “D(0)” in the field of “d” indicates that the interval on the optical axis of the lens surface is a variable interval that changes at the time of Variable magnification or focusing.

In Table 1, each of surface numbers 1 to 5 is a surface number of the lens of first lens group G1. Each of surface numbers 6 to 14 is a surface number of the second lens group G2. The surface number 15 represents a stop. Each of surface numbers 16 to 22 is a surface number of the third lens group G3. Each of surface numbers 23 to 27 is a surface number of the fourth lens group G4. Each of surface numbers 28 to 29 is a surface number of the lens of fifth lens group G5. Each of surface numbers 30 to 35 is a surface number of the sixth lens group G6. The surface number 36 to 37 represents a cover glass (CG).

TABLE 1

| Surface number | r | d | nd | νd |
|---|---|---|---|---|
| Object surface | ∞ | d(0) | | |
| 1 | 5402.8349 | 1.7000 | 1.84666 | 23.78 |
| 2 | 247.5120 | 6.9802 | 1.49700 | 81.61 |
| 3 | −234.2591 | 0.2000 | | |
| 4 | 60.6817 | 7.3816 | 1.72916 | 54.67 |
| 5 | 155.7737 | d(5) | | |
| 6 | 78.0464 | 1.5000 | 1.72916 | 54.67 |
| 7 | 20.5900 | 9.1211 | | |
| 8ASPH | −91.9998 | 1.5000 | 1.51633 | 64.06 |
| 9ASPH | 511.0181 | 3.9786 | | |
| 10 | −42.7291 | 1.2000 | 1.49700 | 81.61 |
| 11 | 59.7131 | 7.4736 | 1.60342 | 38.01 |
| 12 | −32.7331 | 2.2573 | | |
| 13ASPH | −20.2370 | 1.5000 | 1.59201 | 67.02 |
| 14ASPH | −31.5949 | d(14) | | |
| 15S | ∞ | 1.0000 | | |
| 16 | 37.8208 | 5.8112 | 1.92286 | 20.88 |
| 17 | 179.4192 | 0.5000 | | |
| 18 | 51.0737 | 1.2000 | 1.90366 | 31.31 |
| 19 | 20.8927 | 10.3180 | 1.59282 | 68.62 |
| 20 | −559.8174 | 2.8570 | | |
| 21 | −45.6201 | 1.0000 | 1.92286 | 20.88 |
| 22 | 144.7843 | d(22) | | |
| 23 | 33.6250 | 1.0000 | 1.87070 | 40.73 |
| 24 | 20.1801 | 13.5982 | 1.59282 | 68.62 |
| 25 | −73.2918 | 0.1500 | | |
| 26ASPH | 37.2974 | 7.2684 | 1.59201 | 67.02 |
| 27ASPH | −64.8061 | d(27) | | |
| 28 | 66.0293 | 0.9000 | 1.83481 | 42.72 |
| 29 | 26.0936 | d(29) | | |
| 30 | 68.7274 | 6.2835 | 1.80518 | 25.46 |
| 31 | −47.4786 | 0.1500 | | |
| 32ASPH | −69.2213 | 1.5000 | 1.77377 | 47.17 |
| 33ASPH | 116.9797 | 7.9477 | | |
| 34 | −20.3610 | 1.2000 | 1.83481 | 42.72 |
| 35 | −34.5463 | d(35) | | |
| 36 | ∞ | 2.5000 | 1.51680 | 64.20 |
| 37 | ∞ | 1.0000 | | |
| image plane | ∞ | | | |

Table 2 shows a specification table of the zoom lens of Example 1.

TABLE 2

| | Wide-angle end | Intermediate | Telephoto end |
|---|---|---|---|
| f | 28.8361 | 40.0054 | 67.9005 |
| FNo. | 2.0600 | 2.0613 | 2.0609 |
| ω | 37.7855 | 27.9037 | 16.8751 |
| Y | 21.6330 | 21.6330 | 21.6330 |

Table 3 shows distances of variable intervals of the zoom lens of Example 1.

TABLE 3

| | Wide-angle end | Intermediate | Telephoto end |
|---|---|---|---|
| d(0) | ∞ | ∞ | ∞ |
| d(5) | 1.0000 | 11.5468 | 30.9112 |
| d(14) | 29.6624 | 17.9669 | 1.3559 |
| d(22) | 0.9055 | 0.8000 | 1.8018 |
| d(27) | 2.1949 | 2.7053 | 3.9280 |
| d(29) | 7.9609 | 7.8481 | 11.6693 |
| d(35) | 13.3000 | 17.0654 | 17.7959 |
| d(0) | 134.0000 | 211.0912 | 271.5617 |
| d(5) | 1.0000 | 11.5468 | 30.9112 |
| d(14) | 29.6624 | 17.9669 | 1.3559 |
| d(22) | 0.9055 | 0.8000 | 1.8018 |
| d(27) | 4.6405 | 5.3385 | 8.8504 |
| d(29) | 5.5154 | 5.2149 | 6.7468 |
| d(35) | 13.3000 | 17.0654 | 17.7959 |

Table 4 shows the focal length of each lens group of the zoom lens of Example 1.

TABLE 4

| Group No. | Focal length |
|---|---|
| G1 | 117.4710 |
| G2 | −29.6588 |
| G3 | 190.1650 |
| G4 | 24.9945 |
| G5 | −52.2155 |
| G6 | −346.7190 |

Table 5 shows aspherical coefficients of aspheric surfaces in the zoom lens of Example 1. An aspherical coefficient in the table is a value when each aspherical shape is defined by following Expression (1).

$$\begin{matrix}[ Math 1 ] & \\ x = \frac{{H}^{2} / r}{1 + \sqrt{1 - ( 1 + k ) {( H / r )}^{2}}} + {A}_{4} {H}^{4} + {A}_{6} {H}^{6} + {A}_{8} {H}^{8} + {A}_{10} {H}^{10} + {A}_{12} {H}^{12} & ( 1 )\end{matrix}$$

In Expression (1), “x” is an amount of displacement from the reference plane in the optical axis direction, “r” is a paraxial curvature radius, “H” is a height from the optical axis in a direction perpendicular to the optical axis, “k” is a conic coefficient, and “An” is an nth-order aspherical coefficient.

TABLE 5

| Surface number | k | A4 | A6 |
|---|---|---|---|
| 8 | 0.0000 | 1.12279E−05 | −1.19074E−08 |
| 9 | 0.0000 | 1.18400E−05 | 2.47416E−09 |
| 13 | 0.0000 | 3.46151E−05 | −7.86166E−08 |
| 14 | 0.0000 | 2.41764E−05 | −9.75381E−08 |
| 26 | 0.0000 | −1.02603E−05 | −5.81510E−09 |
| 27 | 6.5998 | 4.18321E−06 | −5.64567E−09 |
| 32 | 0.0000 | −9.47323E−06 | 9.12347E−08 |
| 33 | 0.0000 | −1.44113E−05 | 6.46613E−08 |

| Surface number | A8 | A10 | A12 |
|---|---|---|---|
| 8 | 4.9265E−13 | 4.55475E−14 | 0.00000E+00 |
| 9 | −8.77722E−12 | 1.48655E−13 | 0.00000E+00 |
| 13 | 2.26606E−10 | −2.04828E−13 | 0.00000E+00 |
| 14 | 2.11579E−10 | −3.04187E−13 | 0.00000E+00 |
| 26 | −3.74566E−11 | 6.3631E−14 | −1.08552E−16 |
| 27 | −4.61082E−11 | 1.49319E−13 | −2.99476E−16 |
| 32 | −1.5746E−10 | −1.26436E−13 | 1.13841E−15 |
| 33 | 6.63953E−12 | −9.17756E−13 | 2.418E−15 |

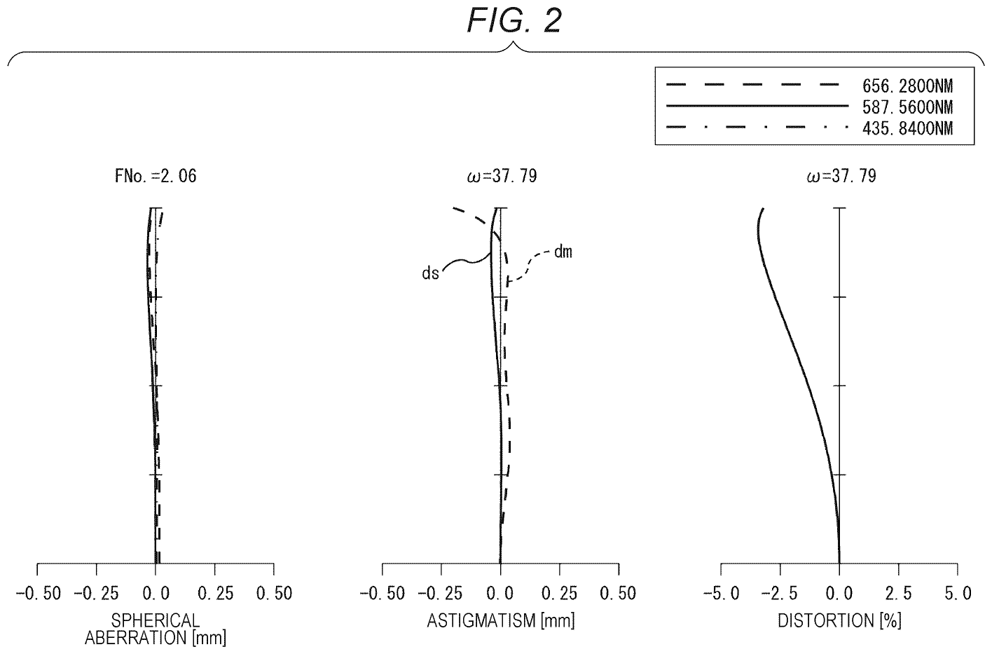

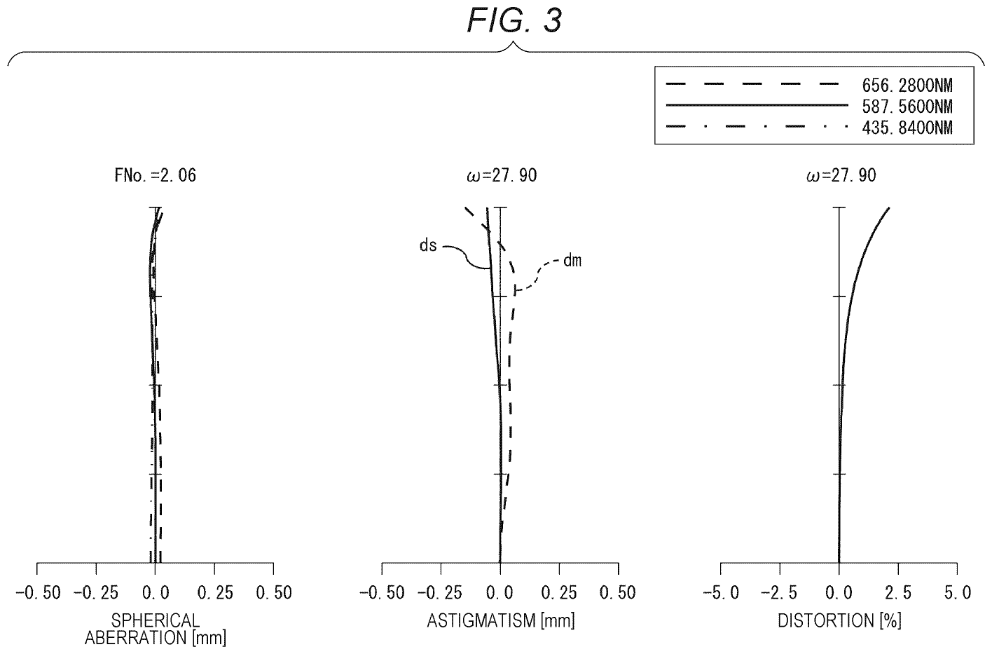

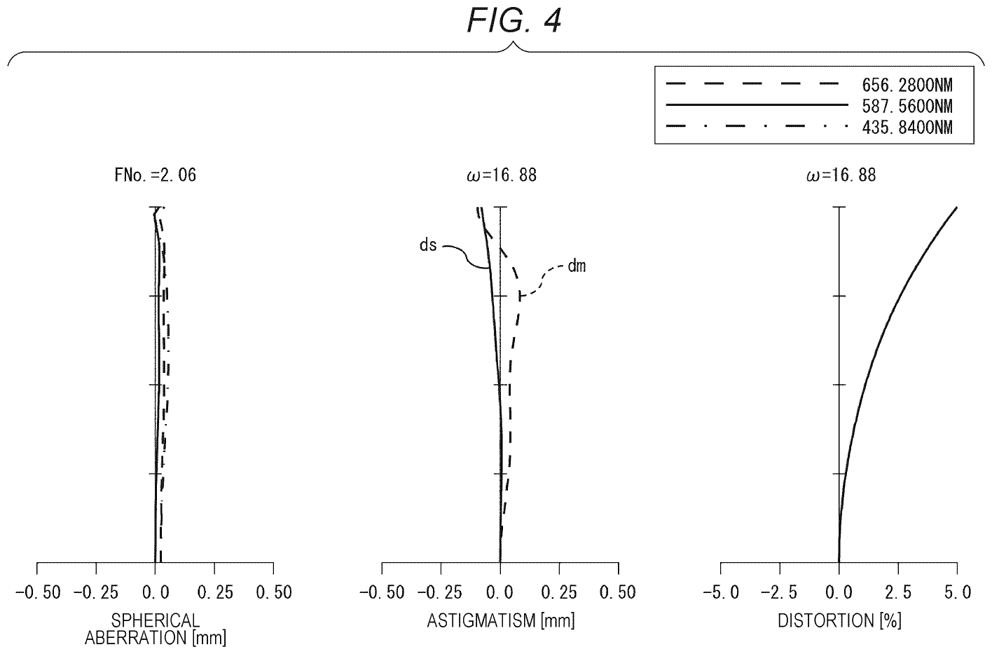

FIG. 2 illustrates a longitudinal aberration diagram of the zoom lens of Example 1 at a wide-angle end at a time of infinity focusing. FIG. 3 illustrates a longitudinal aberration diagram of the zoom lens of Example 1 at an intermediate focal point at a time of infinity focusing. FIG. 4 illustrates a longitudinal aberration diagram of the zoom lens of Example 1 at a telephoto end at a time of infinity focusing. In each drawing, spherical aberration (mm), astigmatism (mm), and distortion (%) are illustrated in order from the left side when viewing the drawing.

In the figure representing the spherical aberration, the vertical axis represents the ratio to the open F number, and the horizontal axis represents the defocus. In the aberration diagram, the solid line indicates spherical aberration at d Line (wavelength: 587.56 nm), the broken line indicates spherical aberration at C Line (wavelength: 656.28 nm), and the alternate long and short dash line indicates spherical aberration at g Line (wavelength: 435.84 nm).

In the diagram representing astigmatism, a solid line indicates a sagittal image plane (ds) with respect to d Line, and a broken line indicates a meridional image plane (dm) with respect to d Line.

In the diagram representing the distortion aberration, the vertical axis represents the image height (mm), and the horizontal axis represents %.

### Example 2

### (1) Configuration of Optical System

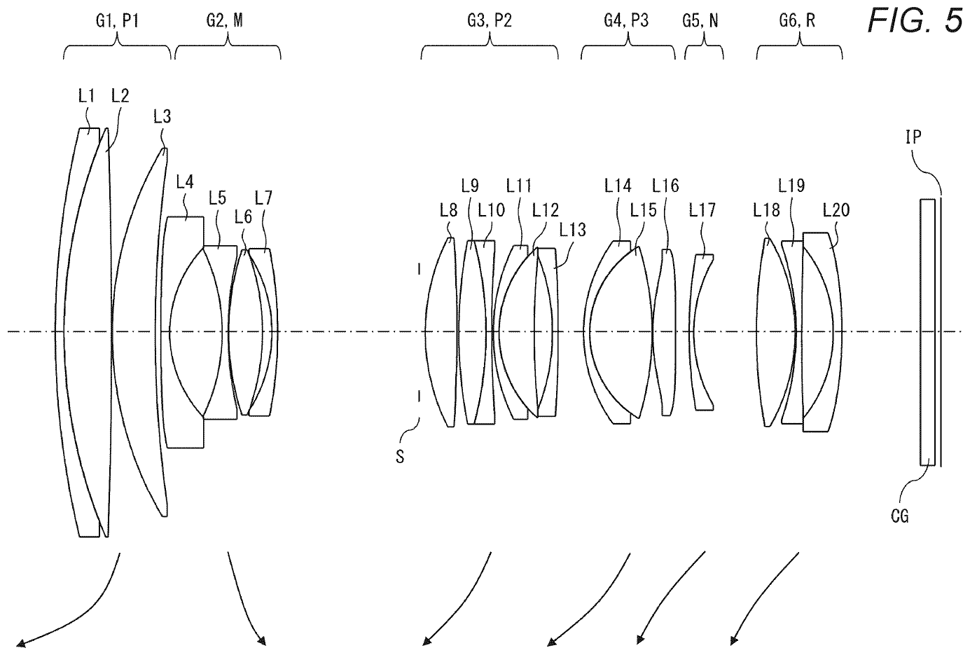

FIG. 5 is a diagram schematically illustrating an optical configuration of the zoom lens of Example 2 at a wide-angle end at a time of infinity focusing. The zoom lens according to Example 2 includes, in order from the object side, the first lens group G1 having positive refractive power, the second lens group G2 having negative refractive power, the third lens group G3 having positive refractive power, the fourth lens group G4 having positive refractive power, the fifth lens group G5 having negative refractive power, and the sixth lens group G6 having negative refractive power.

The first lens group G1 includes, in order from the object side, a cemented lens of a meniscus lens L1 and a biconvex lens L2 having negative refractive power with a convex surface facing the object, and a meniscus lens L3 having positive refractive power with a convex surface facing the object.

The second lens group G2 includes, in order from the object side, the meniscus lens L4 having negative refractive power with a convex surface facing the object, the biconcave lens L5, a biconvex lens L6, and a meniscus lens L7 having negative refractive power with a concave surface facing the object. The meniscus lens L4 having negative refractive power is a glass molded aspherical lens both surfaces of which have an aspherical shape.

The third lens group G3 includes, in order from the object side, a biconvex lens L8, a cemented lens of a biconvex lens L9 and a biconcave lens L10, a cemented lens of a meniscus lens L11 having negative refractive power with a convex surface facing the object and a meniscus lens L12 having positive refractive power with a convex surface facing the object, and the meniscus lens L13 having negative refractive power with a concave surface facing the object.

The fourth lens group G4 includes, in order from the object side, a cemented lens of a meniscus lens L14 and the biconvex lens L15 having negative refractive power with a convex surface facing the object, and a biconvex lens L16. The biconvex lens L16 is a glass molded aspherical lens both surfaces of which have an aspherical shape.

The fifth lens group G5 includes a meniscus lens L17 having negative refractive power with a convex surface facing the object.

The sixth lens group G6 includes a biconvex lens L18, a biconcave lens L19, and a meniscus lens L20 having negative refractive power with a concave surface facing the object. The meniscus lens L20 having negative refractive power is a glass molded aspherical lens both surfaces of which have an aspherical shape.

The aperture stop S is disposed adjacent to the third lens group G3 closer to the object.

The first lens group G1 corresponds to the lens group P1 described above. The second lens group G2 corresponds to the middle group M described above. The third lens group G3 corresponds to the lens group P2 described above. The fourth lens group G4 corresponds to the lens group P3 described above. The fifth lens group G5 corresponds to the lens group N described above. The sixth lens group G6 corresponds to the rear group R described above. The meniscus lens L13 having negative refractive power corresponds to the lens component A described above.

Arrows in FIG. 5 indicate a movement direction and a movement manner of each lens group of the zoom lens of Example 2 at the time of variable magnification from the wide-angle end to the telephoto end. At the time of variable magnification from the wide-angle end to the telephoto end, the first lens group G1 moves toward the object, the second lens group G2 moves toward the image plane, the third lens group G3 moves toward the object, the fourth lens group G4 moves toward the object, the fifth lens group G5 moves toward the object, and the sixth lens group G6 moves toward the object.

Focusing from an infinite-distance object to a short distance object is done by the fifth lens group G5 moving toward the image plane.

### (2) Numerical-Value Examples

Table 6 shows data of each surface included in the zoom lens of Example 2.

TABLE 6

| Surface number | r | d | nd | νd |
|---|---|---|---|---|
| Object surface | ∞ | d(0) | | |
| 1 | 147.9240 | 1.5000 | 2.00100 | 29.13 |
| 2 | 89.2297 | 8.1669 | 1.49700 | 81.61 |
| 3 | −1013.4225 | 0.1500 | | |
| 4 | 62.5899 | 7.3342 | 1.59282 | 68.62 |
| 5 | 217.6192 | d(5) | | |
| 6ASPH | 1146.3450 | 1.5000 | 1.85108 | 40.12 |
| 7ASPH | 21.2737 | 8.9791 | | |
| 8 | −32.8324 | 1.0000 | 1.59282 | 68.62 |
| 9 | 54.7576 | 0.1500 | | |
| 10 | 45.7575 | 5.7592 | 1.77047 | 29.74 |
| 11 | −40.6524 | 1.6538 | | |
| 12 | −24.8195 | 1.0000 | 1.49700 | 81.61 |
| 13 | −72.3565 | d(13) | | |
| 14S | ∞ | 1.0000 | | |
| 15 | 35.6743 | 5.4465 | 1.84666 | 23.78 |
| 16 | −261.9933 | 0.3434 | | |
| 17 | 83.4176 | 4.6628 | 1.49700 | 81.61 |
| 18 | −60.8050 | 1.0000 | 2.00069 | 25.46 |
| 19 | 223.6863 | 0.2000 | | |
| 20 | 33.0763 | 1.0000 | 2.00100 | 29.13 |
| 21 | 19.5530 | 6.0475 | 1.49700 | 81.61 |
| 22 | 137.4886 | 3.1524 | | |
| 23 | −35.6888 | 1.0000 | 1.90366 | 31.31 |
| 24 | −204.7501 | d(24) | | |
| 25 | 26.7857 | 1.1000 | 1.83400 | 37.34 |
| 26 | 17.1629 | 10.6700 | 1.59282 | 68.62 |
| 27 | −49.5364 | 0.1500 | | |
| 28ASPH | 35.1548 | 3.9177 | 1.59201 | 67.02 |
| 29ASPH | −400.2043 | d(29) | | |
| 30 | 75.8566 | 0.8000 | 1.83481 | 42.72 |
| 31 | 24.8752 | d(31) | | |
| 32 | 92.9598 | 6.5913 | 1.84666 | 23.78 |
| 33 | −32.3756 | 0.1500 | | |
| 34 | −47.3662 | 1.0000 | 1.84666 | 23.78 |
| 35 | 457.6853 | 5.3920 | | |
| 36ASPH | −25.6131 | 1.5000 | 1.69350 | 53.18 |
| 37ASPH | −84.9510 | d(37) | | |
| 38 | ∞ | 2.5000 | 1.51680 | 64.20 |
| 39 | ∞ | 1.0000 | | |
| Image plane | ∞ | | | |

Table 7 shows a specification table of the zoom lens of Example 2.

TABLE 7

| | Wide-angle end | Intermediate | Telephoto end |
|---|---|---|---|
| f | 25.7043 | 39.9974 | 96.9898 |
| FNo. | 2.9082 | 2.9084 | 2.9109 |
| ω | 41.9883 | 28.0844 | 11.9873 |
| Y | 21.6330 | 21.6330 | 21.6330 |

Table 8 shows the distance of each variable interval of the zoom lens of Example 2.

TABLE 8

| | Wide-angle end | Intermediate | Telephoto end |
|---|---|---|---|
| d(0) | ∞ | ∞ | ∞ |
| d(5) | 1.0000 | 11.8903 | 44.9323 |
| d(13) | 24.2967 | 15.3815 | 1.1000 |
| d(24) | 4.3009 | 2.1402 | 0.8000 |
| d(29) | 2.2964 | 2.4602 | 5.8854 |
| d(31) | 10.7891 | 10.7561 | 10.7223 |
| d(37) | 13.5000 | 22.4107 | 27.7965 |
| d(0) | 28.0000 | 139.1441 | 362.9468 |
| d(5) | 1.0000 | 11.8903 | 44.9323 |
| d(13) | 24.2967 | 15.3815 | 1.1000 |
| d(24) | 4.3009 | 2.1402 | 0.8000 |
| d(29) | 7.1003 | 5.1342 | 11.0187 |
| d(31) | 5.9852 | 8.0821 | 5.5890 |
| d(37) | 13.5000 | 22.4107 | 27.7965 |

Table 9 shows the focal length of each lens group of the zoom lens of Example 2.

TABLE 9

| Group No. | Focal length |
|---|---|
| G1 | 118.4930 |
| G2 | −21.6505 |
| G3 | 90.9915 |
| G4 | 23.0848 |
| G5 | −44.6553 |
| G6 | −1057.4300 |

Table 10 shows aspherical coefficients of aspheric surfaces in the zoom lens of Example 2.

TABLE 10

| Surface number | k | A4 | A6 |
|---|---|---|---|
| 6 | 0.0000 | 8.15512E−06 | −2.58308E−08 |
| 7 | 0.0000 | 3.01464E−06 | −3.12833E−08 |
| 28 | 3.1421 | −2.62006E−05 | −6.73925E−08 |
| 29 | 0.0000 | 2.45836E−07 | −4.74396E−08 |
| 36 | −2.6052 | −4.31172E−05 | 1.49865E−07 |
| 37 | 0.0000 | −2.01518E−05 | 1.26793E−07 |

| Surface number | A8 | A10 | A12 |
|---|---|---|---|
| 6 | 9.56254E−11 | −1.87198E−13 | 1.86771E−16 |
| 7 | 1.79591E−10 | −8.23604E−13 | 2.01475E−15 |
| 28 | −1.51087E−10 | −5.58708E−13 | 0.00000E+00 |
| 29 | −9.84238E−11 | −3.35970E−13 | 0.00000E+00 |
| 36 | −4.98188E−10 | 4.35226E−13 | 0.00000E+00 |
| 37 | −4.42043E−10 | 5.17893E−13 | 0.00000E+00 |

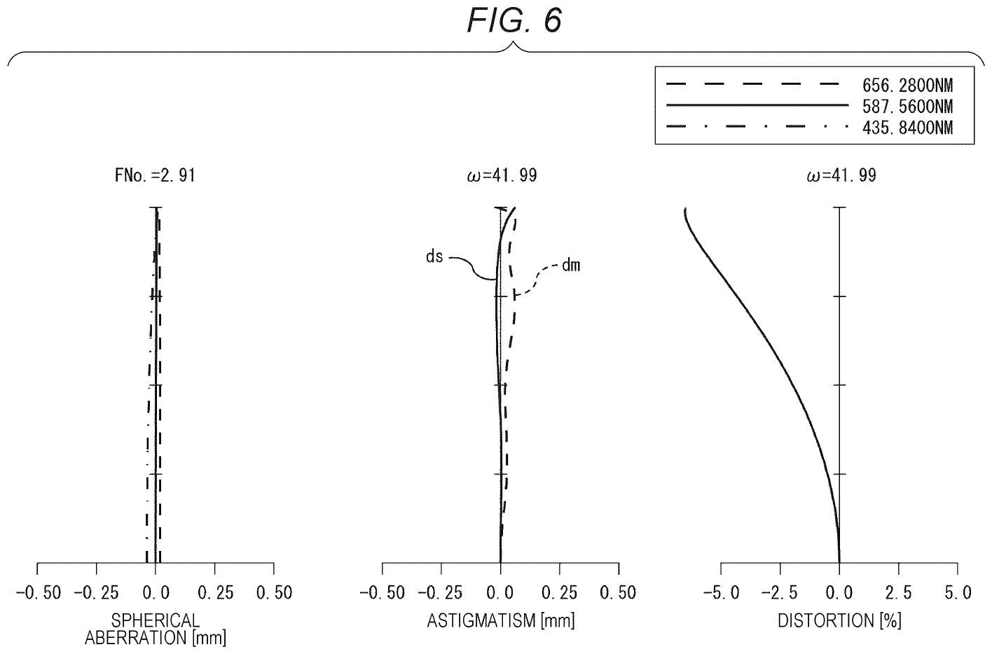

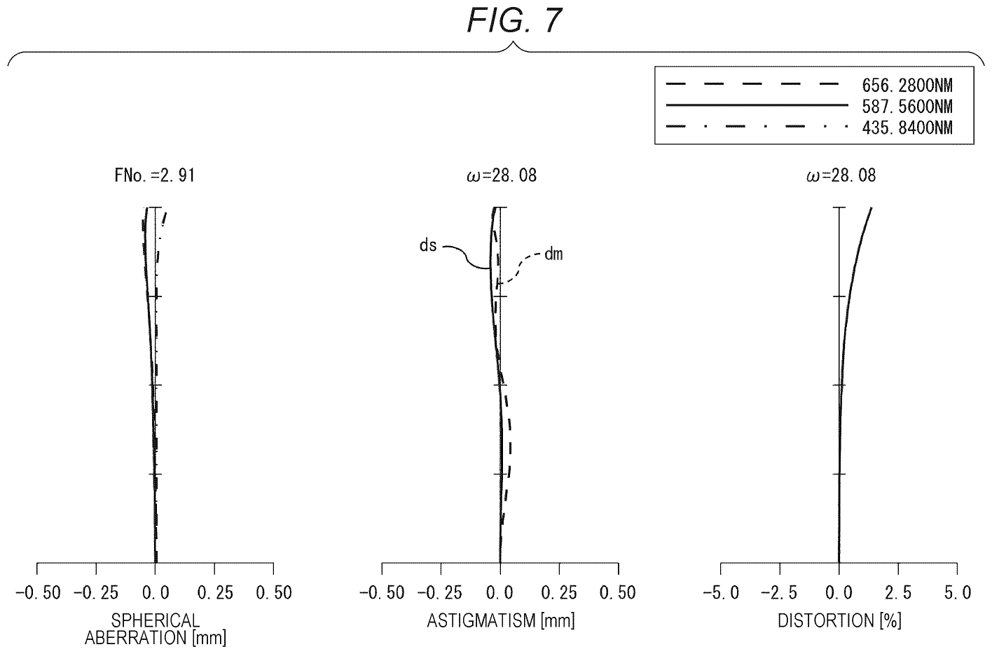

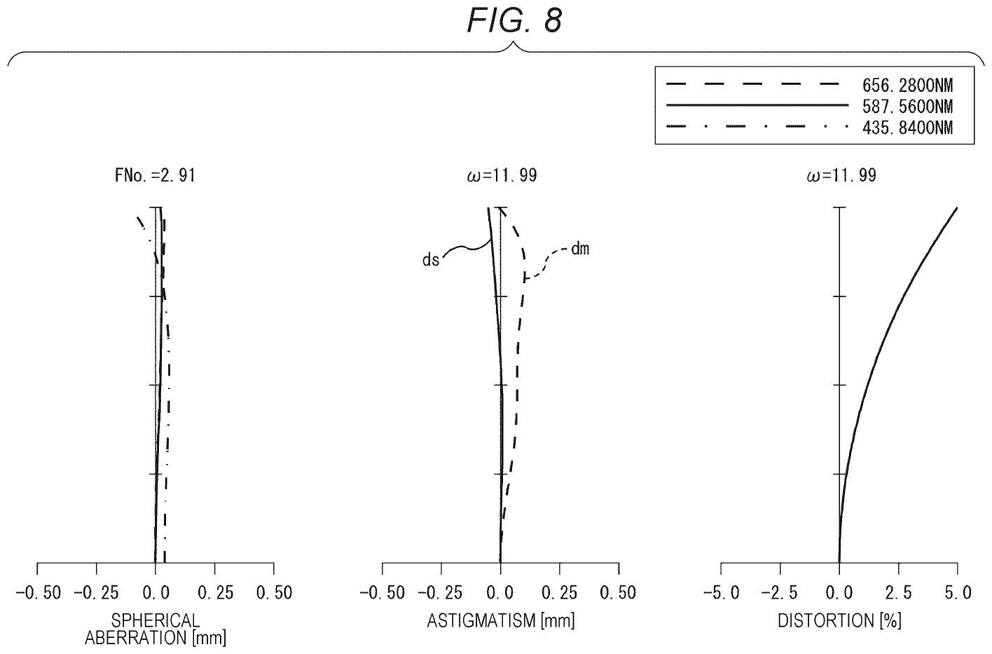

FIG. 6 illustrates a longitudinal aberration diagram of the zoom lens of Example 2 at a wide-angle end at a time of infinity focusing. FIG. 7 illustrates a longitudinal aberration diagram of the zoom lens of Example 2 at an intermediate focal point at a time of infinity focusing. FIG. 8 illustrates a longitudinal aberration diagram of the zoom lens of Example 2 at a telephoto end at a time of infinity focusing.

### Example 3

### (1) Configuration of Optical System

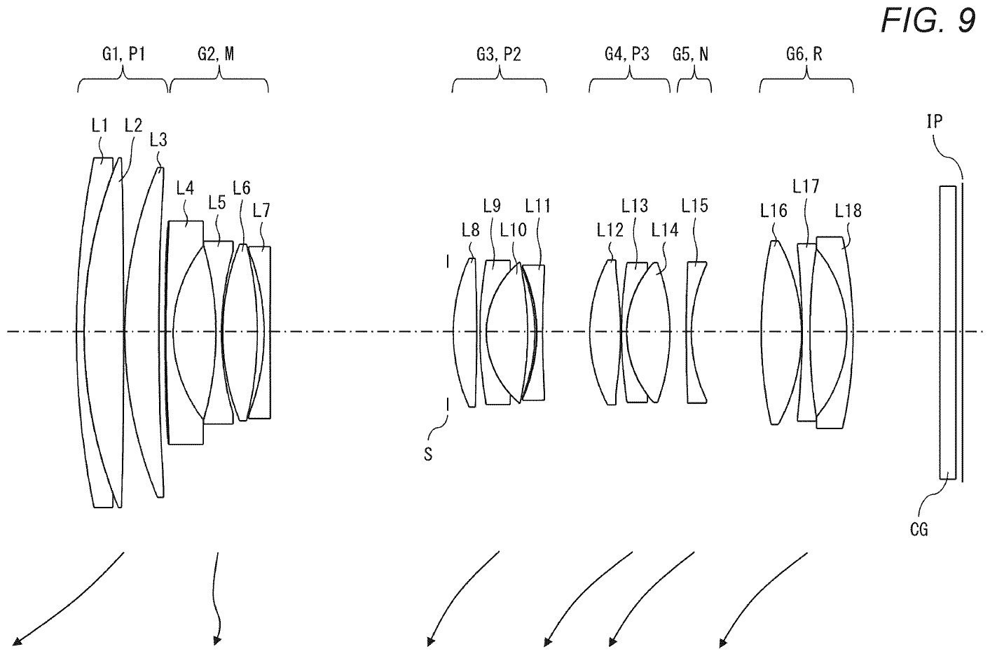

FIG. 9 is a diagram schematically illustrating an optical configuration of the zoom lens of Example 3 at a wide-angle end at a time of infinity focusing. The zoom lens according to Example 3 includes, in order from the object side, the first lens group G1 having positive refractive power, the second lens group G2 having negative refractive power, the third lens group G3 having positive refractive power, the fourth lens group G4 having positive refractive power, the fifth lens group G5 having negative refractive power, and the sixth lens group G6 having negative refractive power.

The first lens group G1 includes, in order from the object side, a cemented lens of a meniscus lens L1 and a biconvex lens L2 having negative refractive power with a convex surface facing the object, and a meniscus lens L3 having positive refractive power with a convex surface facing the object.

The second lens group G2 includes, in order from the object side, the meniscus lens L4 having negative refractive power with a convex surface facing the object, the biconcave lens L5, the biconvex lens L6, and a biconcave lens L7. The meniscus lens L4 having negative refractive power is a composite resin aspherical lens in which a composite resin film molded in an aspherical shape is attached to an object side face.

The third lens group G3 includes, in order from the object side, the biconvex lens L8, a cemented lens of the meniscus lens L9 and a biconvex lens L10 having negative refractive power with a convex surface facing the object, and a biconcave lens L11. The biconcave lens L11 is a composite resin aspherical lens in which a composite resin film molded in an aspherical shape is attached to an object side face.

The fourth lens group G4 includes, in order from the object side, a biconvex lens L12, and a cemented lens of the meniscus lens L13 and the biconvex lens L14 having negative refractive power with a convex surface facing the object. The biconvex lens L12 is a glass molded aspherical lens both surfaces of which have an aspherical shape.

The fifth lens group G5 includes a meniscus lens L15 having negative refractive power with a convex surface facing the object.

The sixth lens group G6 includes the biconvex lens L16, a biconcave lens L17, and a meniscus lens L18 having negative refractive power with a concave surface facing the object. The biconcave lens L17 is a glass molded aspherical lens both surfaces of which have an aspherical shape.

The aperture stop S is disposed adjacent to the third lens group G3 closer to the object.

The first lens group G1 corresponds to the lens group P1 described above. The second lens group G2 corresponds to the middle group M described above. The third lens group G3 corresponds to the lens group P2 described above. The fourth lens group G4 corresponds to the lens group P3 described above. The fifth lens group G5 corresponds to the lens group N described above. The sixth lens group G6 corresponds to the rear group R described above. The biconcave lens L11 corresponds to the lens component A described above.

Arrows in FIG. 9 indicate a movement direction and a movement manner of each lens group of the zoom lens of Example 3 at the time of variable magnification from the wide-angle end to the telephoto end. At the time of variable magnification from the wide-angle end to the telephoto end, the first lens group G1 moves toward the object, the second lens group G2 moves toward the image plane, the third lens group G3 moves toward the object, the fourth lens group G4 moves toward the object, the fifth lens group G5 moves toward the object, and the sixth lens group G6 moves toward the object.

Focusing from an infinite-distance object to a short distance object is done by the fifth lens group G5 moving toward the image plane.

(2) Numerical-Value Examples Table 11 shows data of each surface included in the zoom lens of Example 3.

TABLE 11

| Surface number | r | d | nd | νd |
|---|---|---|---|---|
| Object surface | ∞ | d(0) | | |
| 1 | 138.2908 | 1.2000 | 1.80610 | 33.27 |
| 2 | 71.8697 | 6.1991 | 1.43700 | 95.10 |
| 3 | −988.4424 | 0.1500 | | |
| 4 | 67.3585 | 5.2760 | 1.59282 | 68.62 |
| 5 | 393.4351 | d(5) | | |
| 6ASPH | 573.0039 | 0.1500 | 1.53610 | 41.21 |
| 7 | 321.4213 | 1.1000 | 1.87070 | 40.73 |
| 8 | 21.9192 | 6.6163 | | |
| 9 | −49.5626 | 0.9000 | 1.61800 | 63.39 |
| 10 | 45.1799 | 0.2000 | | |
| 11 | 37.8072 | 5.3924 | 1.76182 | 26.61 |
| 12 | −56.7238 | 1.0469 | | |
| 13 | −35.3413 | 0.9000 | 1.49700 | 81.61 |
| 14 | 1826.5869 | d(14) | | |
| 15S | ∞ | 0.9000 | | |
| 16 | 28.6445 | 3.6114 | 1.72825 | 28.32 |
| 17 | −348.1430 | 0.4976 | | |
| 18 | 64.4085 | 1.0000 | 1.87070 | 40.73 |
| 19 | 14.2600 | 6.4318 | 1.71300 | 53.94 |
| 20 | −51.1336 | 1.1604 | | |
| 21ASPH | −24.1532 | 0.2500 | 1.53610 | 41.21 |
| 22 | −24.9658 | 0.9000 | 1.90366 | 31.31 |
| 23 | 153.0864 | d(23) | | |
| 24ASPH | 23.2470 | 4.8366 | 1.69350 | 53.18 |
| 25ASPH | −47.0915 | 0.1500 | | |
| 26 | 72.4595 | 0.8000 | 1.91082 | 35.25 |
| 27 | 16.3102 | 6.7146 | 1.49700 | 81.61 |
| 28 | −31.0772 | d(28) | | |
| 29 | 270.9536 | 0.8000 | 1.74330 | 49.22 |
| 30 | 24.9181 | d(30) | | |
| 31 | 66.2570 | 6.2513 | 1.74077 | 27.76 |
| 32 | −30.1383 | 0.1500 | | |
| 33ASPH | −80.1228 | 1.2000 | 1.77377 | 47.17 |
| 34ASPH | 143.2701 | 5.7280 | | |
| 35 | −20.4217 | 1.0000 | 1.83481 | 42.72 |
| 36 | −65.8384 | d(36) | | |
| 37 | ∞ | 2.5000 | 1.51680 | 64.20 |
| 38 | ∞ | 1.0000 | | |
| Image plane | ∞ | | | |

Table 12 shows a specification table of the zoom lens of Example 3.

TABLE 12

| | Wide-angle end | Intermediate | Telephoto end |
|---|---|---|---|
| f | 25.7546 | 69.9544 | 193.9096 |
| FNo. | 2.9057 | 4.8999 | 5.8078 |
| ω | 42.1987 | 16.4979 | 6.0975 |
| Y | 21.6330 | 21.6330 | 21.6330 |

Table 13 shows the distance of each variable interval of the zoom lens of Example 3.

TABLE 13

| | Wide-angle end | Intermediate | Telephoto end |
|---|---|---|---|
| d(0) | ∞ | ∞ | ∞ |
| d(5) | 1.0000 | 25.8321 | 60.1497 |
| d(14) | 27.6992 | 12.5791 | 2.2253 |
| d(23) | 7.3672 | 3.3794 | 0.9000 |
| d(28) | 2.5516 | 3.1846 | 3.5983 |
| d(30) | 10.8695 | 10.2367 | 9.8243 |
| d(36) | 13.5000 | 34.6456 | 46.2901 |
| d(0) | 52.0000 | 335.1301 | 601.9999 |
| d(5) | 1.0000 | 25.8321 | 60.1497 |
| d(14) | 27.6992 | 12.5791 | 2.2253 |
| d(23) | 7.3672 | 3.3794 | 0.9000 |
| d(28) | 5.2579 | 5.0519 | 9.2535 |
| d(30) | 8.1632 | 8.3694 | 4.1690 |
| d(36) | 13.5000 | 34.6456 | 46.2901 |

Table 14 shows the focal length of each lens group of the zoom lens of Example 3.

TABLE 14

| Group No. | Focal length |
|---|---|
| G1 | 118.4280 |
| G2 | −21.5568 |
| G3 | 110.9760 |
| G4 | 22.6744 |
| G5 | −36.9701 |
| G6 | −393.4930 |

Table 15 shows aspherical coefficients of aspheric surfaces in the zoom lens of Example 3.

TABLE 15

| Surface number | k | A4 | A6 |
|---|---|---|---|
| 6 | 0.0000 | 3.47547E−06 | −6.46906E−09 |
| 21 | −0.6908 | 1.58671E−05 | −3.34765E−08 |
| 24 | −0.1672 | −1.06914E−05 | 6.20122E−08 |
| 25 | 1.6757 | 3.10823E−05 | −1.62150E−08 |
| 33 | 0.0000 | 3.59573E−05 | −3.20004E−07 |
| 34 | 0.0000 | 3.71296E−05 | −3.11950E−07 |

| Surface number | A8 | A10 | A12 |
|---|---|---|---|
| 6 | 1.20971E−11 | −8.06212E−15 | 0.00000E+00 |
| 21 | 6.78963E−10 | −4.79627E−12 | 1.18873E−14 |
| 24 | −1.07651E−10 | −1.38851E−12 | 8.03578E−15 |
| 25 | 4.82024E−10 | −6.07374E−12 | 2.25207E−14 |
| 33 | 1.35042E−09 | −1.88981E−12 | 0.00000E+00 |
| 34 | 1.20140E−09 | −1.27418E−12 | 0.00000E+00 |

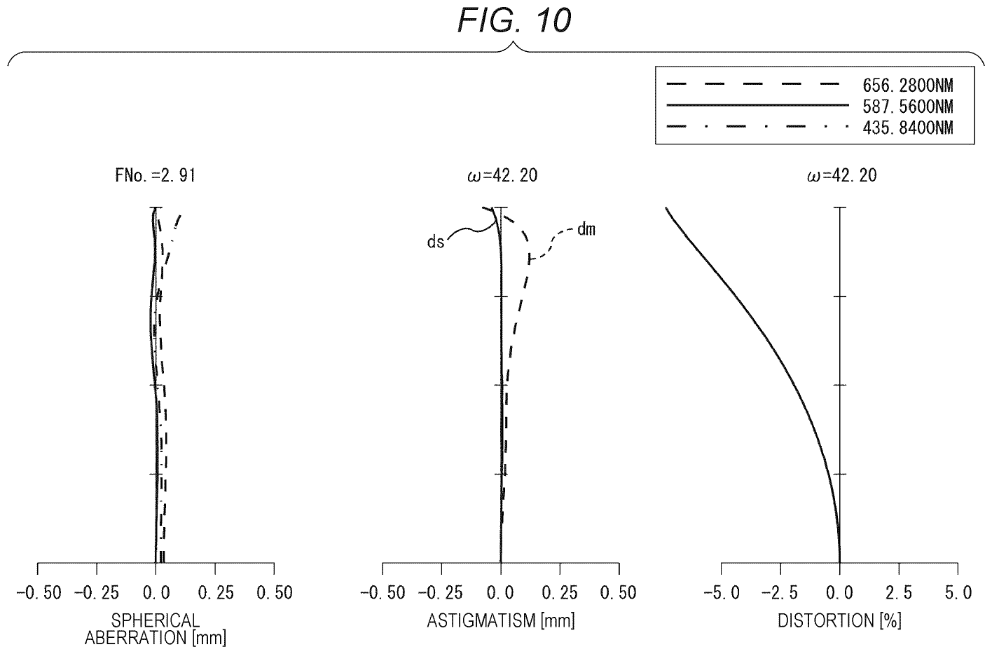

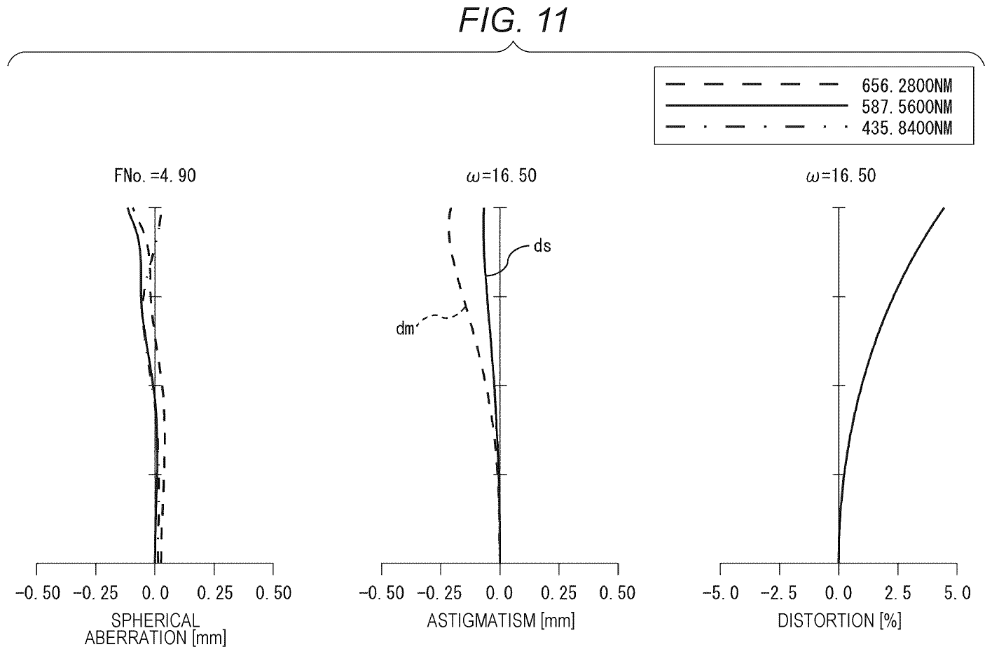

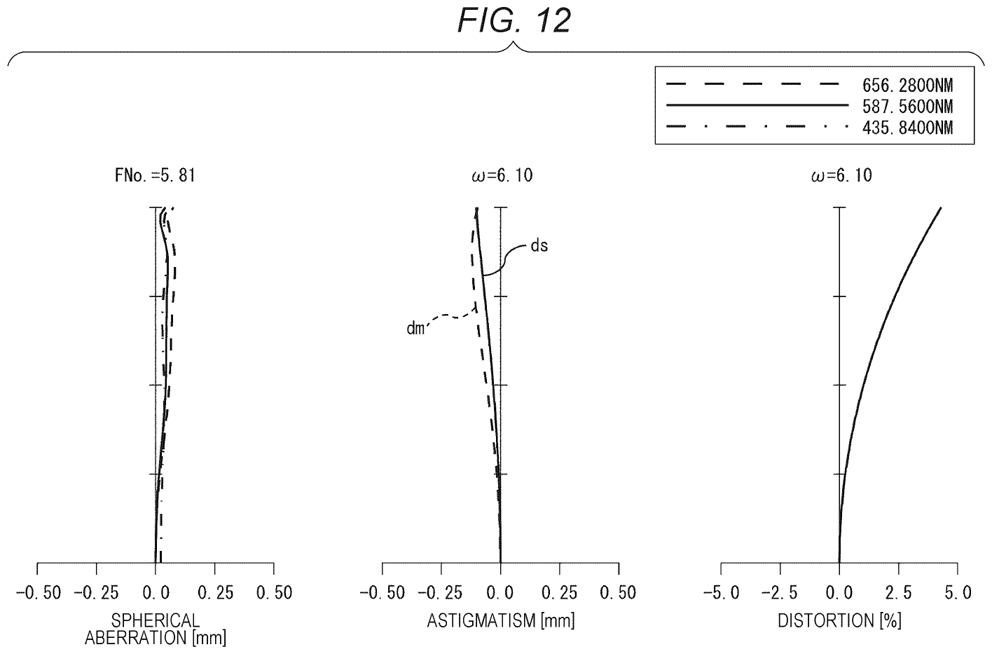

FIG. 10 illustrates a longitudinal aberration diagram of the zoom lens of Example 3 at a wide-angle end at a time of infinity focusing. FIG. 11 illustrates a longitudinal aberration diagram of the zoom lens of Example 3 at an intermediate focal point at a time of infinity focusing. FIG. 12 illustrates a longitudinal aberration diagram of the zoom lens of Example 3 at a telephoto end at a time of infinity focusing.

### Example 4

### (1) Configuration of Optical System

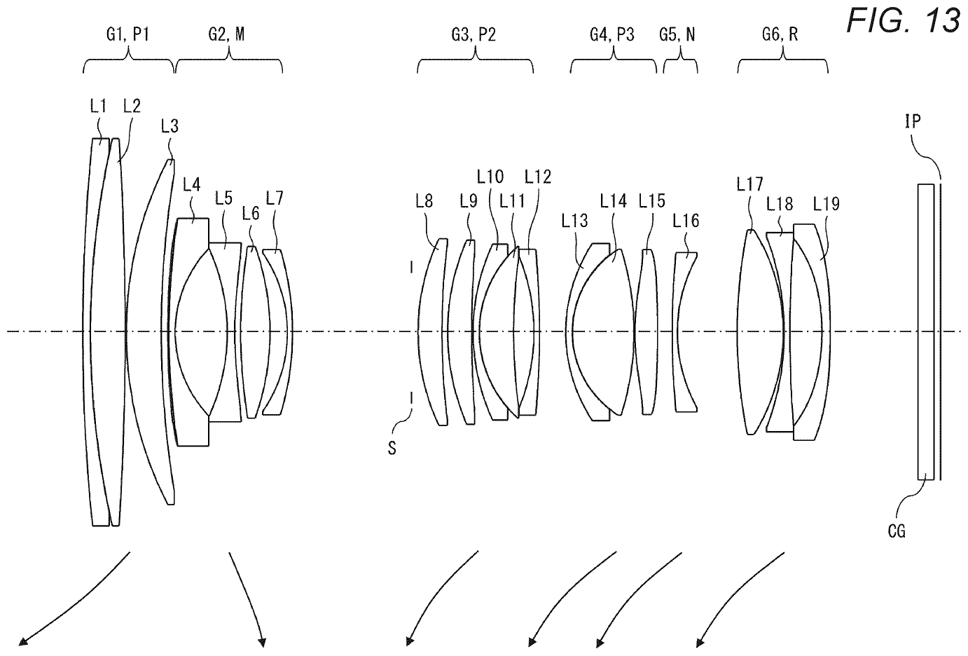

FIG. 13 is a diagram schematically showing an optical configuration of the zoom lens of Example 4 at a wide-angle end at a time of infinity focusing. The zoom lens according to Example 4 includes, in order from the object side, the first lens group G1 having positive refractive power, the second lens group G2 having negative refractive power, the third lens group G3 having positive refractive power, the fourth lens group G4 having positive refractive power, the fifth lens group G5 having negative refractive power, and the sixth lens group G6 having positive refractive power.

The aperture stop S is disposed adjacent to the third lens group G3 closer to the object.

The first lens group G1 corresponds to the lens group P1 described above. The second lens group G2 corresponds to the middle group M described above. The third lens group G3 corresponds to the lens group P2 described above. The fourth lens group G4 corresponds to the lens group P3 described above. The fifth lens group G5 corresponds to the lens group N described above. The sixth lens group G6 corresponds to the rear group R described above. The meniscus lens L12 having negative refractive power corresponds to the lens component A described above.

The first lens group G1 includes, in order from the object side, a cemented lens of a meniscus lens L1 and a biconvex lens L2 having negative refractive power with a convex surface facing the object, and a meniscus lens L3 having positive refractive power with a convex surface facing the object.

The second lens group G2 includes, in order from the object side, the meniscus lens L4 having negative refractive power with a convex surface facing the object, the biconcave lens L5, a biconvex lens L6, and a meniscus lens L7 having negative refractive power with a concave surface facing the object. The meniscus lens L4 having negative refractive power is a composite resin aspherical lens in which a composite resin film molded in an aspherical shape is attached to an object side face. The third lens group G3 includes, in order from the object side, the meniscus lens L8 having positive refractive power with a convex surface facing the object, the meniscus lens L9 having positive refractive power with a convex surface facing the object, a cemented lens of the meniscus lens L10 having negative refractive power with a convex surface facing the object and the meniscus lens L11 having positive refractive power with a convex surface facing the object, and the meniscus lens L12 having negative refractive power with a concave surface facing the object.

The fourth lens group G4 includes, in order from the object side, a cemented lens including the meniscus lens L13 having negative refractive power with a convex surface facing the object and the biconvex lens L14, and the biconvex lens L15. The biconvex lens L15 is a glass molded aspherical lens both surfaces of which have an aspherical shape.

The fifth lens group G5 includes a meniscus lens L16 having negative refractive power with a convex surface facing the object.

The sixth lens group G6 includes a biconvex lens L17, a biconcave lens L18, and a meniscus lens L19 having negative refractive power with a concave surface facing the object. The negative meniscus lens L19 is a glass molded aspherical lens both surfaces of which have an aspherical shape.

The aperture stop S is disposed adjacent to the third lens group G3 closer to the object.

The first lens group G1 corresponds to the lens group P1 described above. The second lens group G2 corresponds to the middle group M described above. The third lens group G3 corresponds to the lens group P2 described above. The fourth lens group G4 corresponds to the lens group P3 described above. The fifth lens group G5 corresponds to the lens group N described above. The sixth lens group G6 corresponds to the rear group R described above. The meniscus lens L12 having negative refractive power corresponds to the lens component A described above.

Arrows in FIG. 13 indicate a movement direction and a movement manner of each lens group of the zoom lens of Example 4 at the time of variable magnification from the wide-angle end to the telephoto end. At the time of variable magnification from the wide-angle end to the telephoto end, the first lens group G1 moves toward the object, the second lens group G2 moves toward the image plane, the third lens group G3 moves toward the object, the fourth lens group G4 moves toward the object, the fifth lens group G5 moves toward the object, and the sixth lens group G6 moves toward the object.

Focusing from an infinite-distance object to a short distance object is done by the fifth lens group G5 moving toward the image plane.

### (2) Numerical-Value Examples

Table 16 shows data of each surface included in the zoom lens of Example 4.

TABLE 16

| Surface number | r | d | nd | νd |
|---|---|---|---|---|
| Object surface | ∞ | d(0) | | |
| 1 | 296.6831 | 1.2000 | 1.92286 | 20.88 |
| 2 | 134.1778 | 5.3920 | 1.49700 | 81.61 |
| 3 | −471.7083 | 0.1500 | | |
| 4 | 58.6469 | 5.3973 | 1.71300 | 53.94 |
| 5 | 151.2506 | d(5) | | |
| 6ASPH | 150.4957 | 0.1500 | 1.53610 | 41.21 |
| 7 | 113.4623 | 1.0000 | 1.83481 | 42.72 |
| 8 | 18.7143 | 8.0145 | | |
| 9ASPH | −30.9776 | 1.2000 | 1.59201 | 67.02 |
| 10ASPH | 64.5070 | 0.9138 | | |
| 11 | 81.5363 | 4.5034 | 1.85883 | 30.00 |
| 12 | −39.0770 | 2.6889 | | |
| 13 | −21.4086 | 0.8000 | 1.49700 | 81.61 |
| 14 | −43.2664 | d(14) | | |
| 15S | ∞ | 1.0000 | | |
| 16 | 33.6847 | 3.7131 | 1.84666 | 23.78 |
| 17 | 112.2668 | 0.8479 | | |
| 18 | 36.2397 | 3.7139 | 1.49700 | 81.61 |
| 19 | 172.4471 | 0.2486 | | |
| 20 | 32.3567 | 0.9000 | 2.00100 | 29.13 |
| 21 | 17.6460 | 5.3332 | 1.49700 | 81.61 |
| 22 | 84.1237 | 3.1191 | | |
| 23 | −31.1917 | 0.9000 | 1.90110 | 27.06 |
| 24 | −131.8726 | d(24) | | |
| 25 | 24.7660 | 1.0000 | 1.87070 | 40.73 |
| 26 | 15.1370 | 9.5165 | 1.59282 | 68.62 |
| 27 | −42.2846 | 0.1500 | | |
| 28ASPH | 37.8209 | 3.5040 | 1.59201 | 67.02 |
| 29ASPH | −236.9395 | d(29) | | |
| 30 | 129.9592 | 0.8000 | 1.80420 | 46.50 |
| 31 | 24.1132 | 9.2212 | | |
| 32 | 80.7795 | 7.0611 | 1.85883 | 30.00 |
| 33 | −30.1291 | 0.1500 | | |
| 34 | −41.6003 | 0.9000 | 1.80000 | 29.84 |
| 35 | 190.9861 | 4.9812 | | |
| 36ASPH | −33.2555 | 1.3000 | 1.69350 | 53.18 |
| 37ASPH | −100.3331 | d(37) | | |
| 38 | ∞ | 2.5000 | 1.51680 | 64.20 |
| 39 | ∞ | 1.0000 | | |
| Image plane | ∞ | | | |

Table 17 shows a specification table of the zoom lens of Example 4.

TABLE 17

| | Wide-angle end | Intermediate | Telephoto end |
|---|---|---|---|
| f | 25.7546 | 35.0033 | 67.8990 |
| FNo. | 2.9145 | 2.9088 | 2.9111 |
| ω | 41.6631 | 31.7316 | 16.8781 |
| Y | 21.6330 | 21.6330 | 21.6330 |

Table 18 shows the distance of each variable interval of the zoom lens of Example 4.

TABLE 18

| | Wide-angle end | Intermediate | Telephoto end |
|---|---|---|---|
| d(0) | ∞ | ∞ | ∞ |
| d(5) | 1.0000 | 6.9228 | 31.1977 |
| d(14) | 18.3845 | 11.3837 | 1.1000 |
| d(24) | 4.0497 | 2.5058 | 0.8000 |
| d(29) | 2.2963 | 2.3578 | 3.7918 |
| d(30) | 9.2212 | 9.1596 | 7.7257 |
| d(37) | 13.5001 | 20.0168 | 28.6047 |
| d(0) | 47.4999 | 143.6051 | 222.7317 |
| d(5) | 1.0000 | 6.9228 | 31.1977 |
| d(14) | 18.3845 | 11.3837 | 1.1000 |
| d(24) | 4.0497 | 2.5058 | 0.8000 |
| d(29) | 5.9266 | 4.5611 | 7.7281 |
| d(30) | 5.5909 | 6.9563 | 3.7894 |
| d(37) | 13.5001 | 20.0168 | 28.6047 |

Table 19 shows the focal length of each lens group of the zoom lens of Example 4.

TABLE 19

| Group No. | Focal length |
|---|---|
| G1 | 116.0210 |
| G2 | −22.2393 |
| G3 | 77.8801 |
| G4 | 22.1736 |
| G5 | −36.9394 |
| G6 | 275.7600 |

Table 20 shows aspherical coefficients of aspheric surfaces in the zoom lens of Example 4.

TABLE 20

| Surface number | k | A4 | A6 |
|---|---|---|---|
| 6 | 0.0000 | 2.50501E−06 | 5.94770E−09 |
| 9 | 0.0000 | −7.41327E−07 | 1.16639E−08 |
| 10 | 0.0000 | −1.39080E−05 | 2.05285E−08 |
| 28 | 5.3869 | −3.54718E−05 | −1.17535E−07 |
| 29 | 0.0000 | −3.60481E−06 | −9.22916E−08 |
| 36 | −2.6692 | −4.51555E−05 | 1.34822E−07 |
| 37 | 0.0000 | −2.78980E−05 | 1.36510E−07 |

| Surface number | A8 | A10 | A12 |
|---|---|---|---|
| 6 | −3.74581E−11 | 1.29604E−13 | 0.00000E+00 |
| 9 | 2.11265E−10 | −2.75877E−12 | 7.76677E−15 |
| 10 | 4.20522E−12 | −1.53609E−12 | 5.27214E−15 |
| 28 | −1.45989E−10 | −1.16193E−12 | 0.00000E+00 |
| 29 | −3.70956E−11 | −9.84939E−13 | 0.00000E+00 |
| 36 | −4.33964E−10 | 2.47746E−13 | 0.00000E+00 |
| 37 | −4.64722E−10 | 5.30207E−13 | 0.00000E+00 |

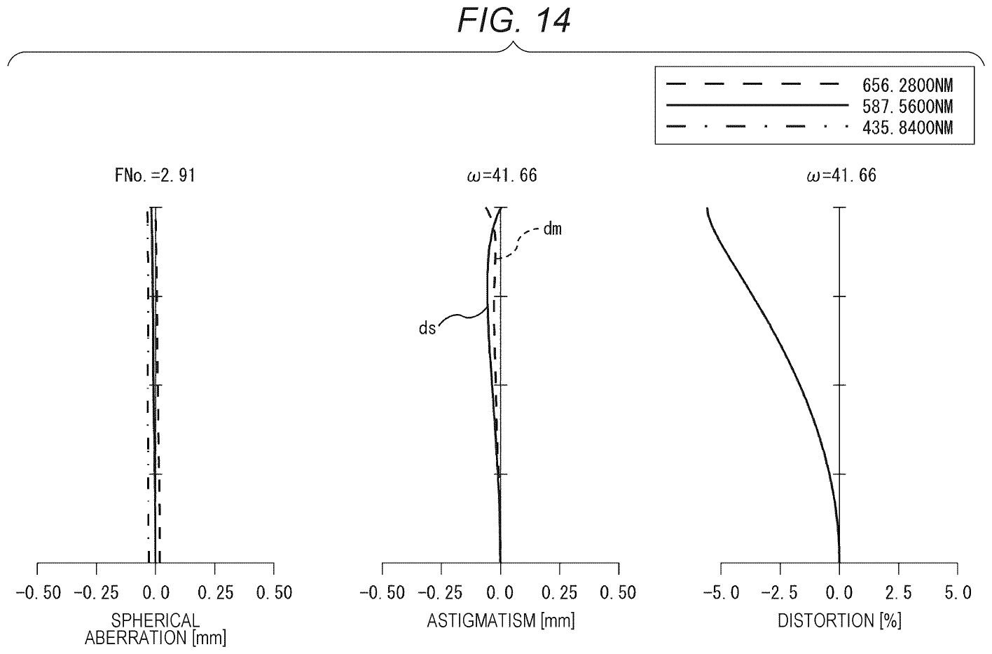

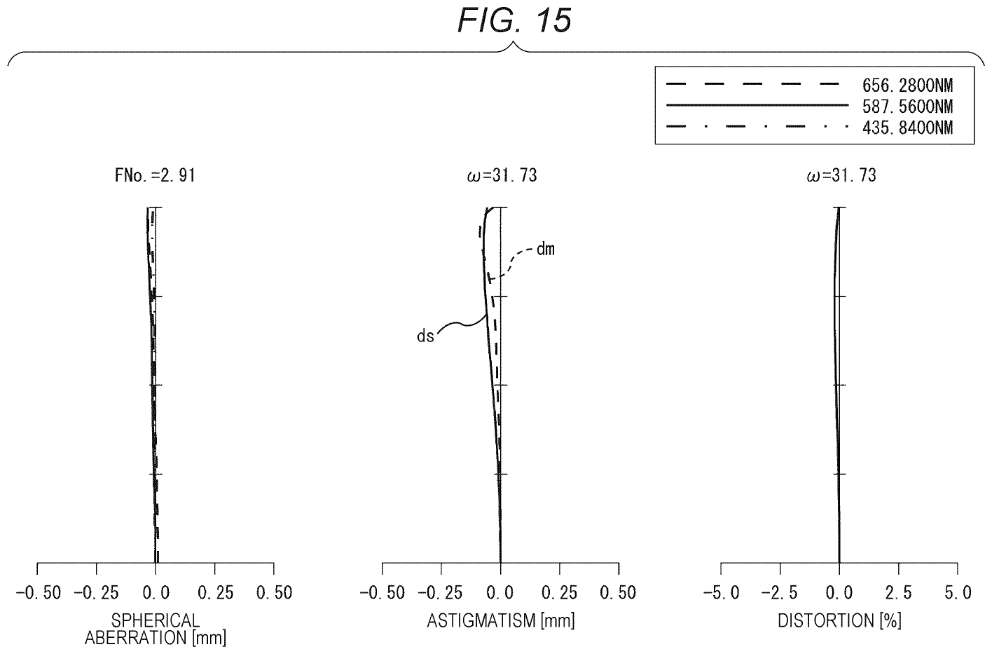

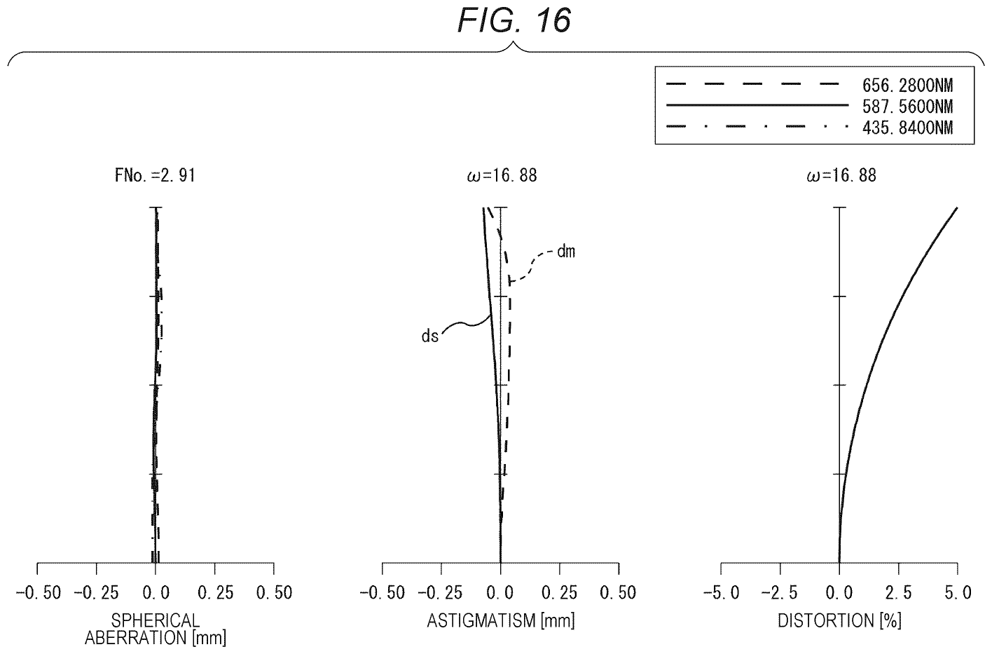

FIG. 14 illustrates a longitudinal aberration diagram of the zoom lens of Example 4 at a wide-angle end at a time of infinity focusing. FIG. 15 illustrates a longitudinal aberration diagram of the zoom lens of Example 4 at an intermediate focal point at a time of infinity focusing. FIG. 16 illustrates a longitudinal aberration diagram of the zoom lens of Example 4 at a telephoto end at a time of infinity focusing.

### Example 5

### (1) Configuration of Optical System

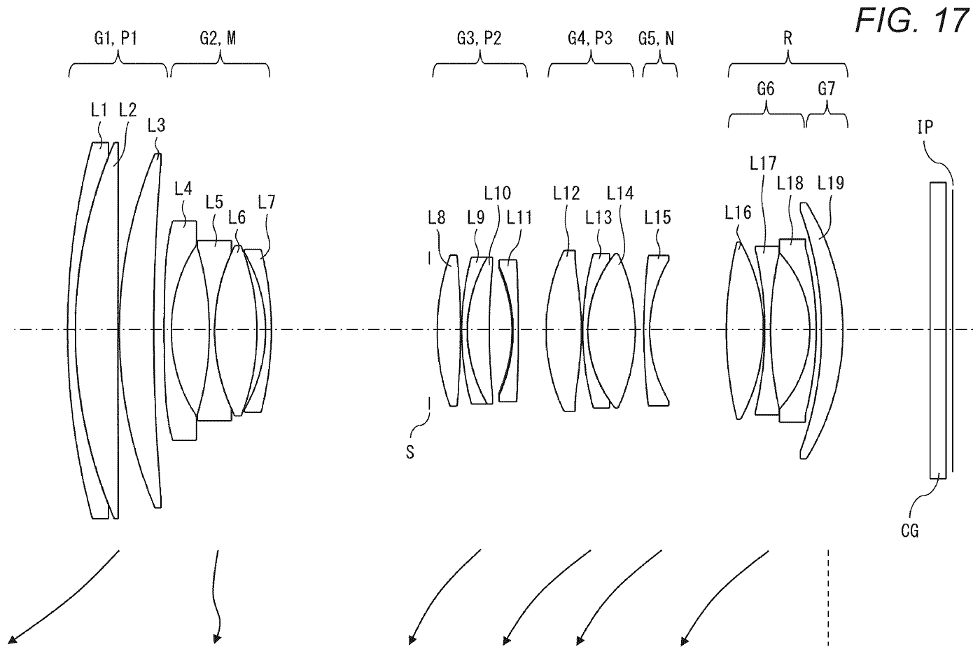

FIG. 17 is a diagram schematically showing an optical configuration of the zoom lens of Example 5 at a wide-angle end at a time of infinity focusing. The zoom lens according to Example 5 includes, in order from an object side, the first lens group G1 having positive refractive power, the second lens group G2 having negative refractive power, the third lens group G3 having positive refractive power, the fourth lens group G4 having positive refractive power, the fifth lens group G5 having negative refractive power, the sixth lens group G6 having negative refractive power, and a seventh lens group G7 having positive refractive power.

The first lens group G1 includes, in order from the object side, a cemented lens of the meniscus lens L1 having negative refractive power with a convex surface facing the object and the meniscus lens L2 having positive refractive power with a convex surface facing the object, and the meniscus lens L3 having positive refractive power with a convex surface facing the object.

The second lens group G2 includes, in order from the object side, the meniscus lens L4 having negative refractive power with a convex surface facing the object, a cemented lenses of the biconcave lens L5 and the biconvex lens L6, and the meniscus lens L7 having negative refractive power with a concave surface facing the object. The meniscus lens L4 having negative refractive power is a glass molded aspherical lens both surfaces of which have an aspherical shape.

The third lens group G3 includes, in order from the object side, the biconvex lens L8, a cemented lens of the meniscus lens L9 having negative refractive power with a convex surface facing the object and the meniscus lens L10 having positive refractive power with a convex surface facing the object, and the meniscus lens L11 having negative refractive power with a concave surface facing the object. The meniscus lens L11 having negative refractive power is a composite resin aspherical lens in which a composite resin film molded in an aspherical shape is attached to an object side face.

The fourth lens group G4 includes, in order from the object side, a biconvex lens L12, and a cemented lens of the meniscus lens L13 and the biconvex lens L14 having negative refractive power with a convex surface facing the object. The biconvex lens L12 is a glass molded aspherical lens both surfaces of which have an aspherical shape.

The fifth lens group G5 includes a meniscus lens L15 having negative refractive power with a convex surface facing the object.

The sixth lens group G6 includes the biconvex lens L16, a biconcave lens L17, and a meniscus lens L18 having negative refractive power with a concave surface facing the object. The meniscus lens L18 having negative refractive power is a glass molded aspherical lens both surfaces of which have an aspherical shape.

The seventh lens group G7 includes the meniscus lens L19 having positive refractive power with a concave surface facing the object.

The aperture stop S is disposed adjacent to the third lens group G3 closer to the object.

The first lens group G1 corresponds to the lens group P1 described above. The second lens group G2 corresponds to the middle group M described above. The third lens group G3 corresponds to the lens group P2 described above. The fourth lens group G4 corresponds to the lens group P3 described above. The fifth lens group G5 corresponds to the lens group N described above. The sixth lens group G6 and seventh lens group G7 correspond to rear group R described above. The meniscus lens L11 having negative refractive power corresponds to the lens component A described above.

Arrows in FIG. 17 indicate a movement direction and a movement manner of each lens group of the zoom lens of Example 5 at the time of variable magnification from the wide-angle end to the telephoto end. In zooming from the wide-angle end to the telephoto end, the first lens group G1 moves toward the object, the second lens group G2 moves toward the object, and then moves toward the image plane, the third lens group G3 moves toward the object, the fourth lens group G4 moves toward the object, the fifth lens group G5 moves toward the object, and the sixth lens group G6 moves toward the object. The seventh lens group G7 is fixed.

### (2) Numerical-Value Examples

Table 21 shows data of each surface included in the zoom lens of Example 5.

TABLE 21
Surface number

| Surface number | r | d | nd | νd |
|---|---|---|---|---|
| Object surface | ∞ | d(0) | | |
| 1 | 110.7216 | 1.2000 | 1.85451 | 25.15 |
| 2 | 72.5779 | 6.6342 | 1.49700 | 81.61 |
| 3 | 5904.4734 | 0.2000 | | |
| 4 | 70.3930 | 5.3298 | 1.59282 | 68.62 |
| 5 | 299.6427 | d(5) | | |
| 6ASPH | 367.3039 | 1.1000 | 1.85108 | 40.12 |
| 7ASPH | 25.7259 | 5.9188 | | |
| 8 | −45.4958 | 0.8000 | 1.87070 | 40.73 |
| 9 | 29.4021 | 6.5753 | 1.84666 | 23.78 |
| 10 | −36.1481 | 1.2911 | | |
| 11 | −24.3260 | 0.9000 | 1.80420 | 46.50 |
| 12 | −51.0707 | d(12) | | |
| 13S | ∞ | 1.2000 | | |
| 14 | 34.5559 | 3.6217 | 1.73037 | 32.23 |
| 15 | −133.5237 | 0.2000 | | |
| 16 | 45.0896 | 0.9000 | 1.84666 | 23.78 |
| 17 | 22.8972 | 3.3750 | 1.49700 | 81.61 |
| 18 | 112.3422 | 3.4962 | | |
| 19ASPH | −22.2277 | 0.1791 | 1.53610 | 41.21 |
| 20 | −23.5450 | 0.8000 | 1.83400 | 37.34 |
| 21 | −226.1977 | d(21) | | |
| 22ASPH | 28.7372 | 5.5000 | 1.69350 | 53.18 |
| 23ASPH | −42.1245 | 0.2000 | | |
| 24 | 44.2837 | 0.8000 | 1.91082 | 35.25 |
| 25 | 18.9412 | 7.3628 | 1.49700 | 81.61 |
| 26 | −27.3898 | d(26) | | |
| 27 | 93.7741 | 0.9000 | 1.59349 | 67.00 |
| 28 | 21.6209 | d(28) | | |
| 29 | 59.0955 | 5.7479 | 1.67270 | 32.17 |
| 30 | −27.9562 | 0.2000 | | |
| 31 | −54.7327 | 0.9000 | 1.72916 | 54.67 |
| 32 | 55.6187 | 6.0527 | | |
| 33ASPH | −17.7852 | 1.0000 | 1.85108 | 40.12 |
| 34ASPH | −46.7904 | d(34) | | |
| 35 | −54.1638 | 3.3102 | 1.72916 | 54.67 |
| 36 | −37.3895 | 13.5000 | | |
| 37 | ∞ | 2.5000 | 1.51680 | 64.20 |
| 38 | ∞ | 1.0000 | | |
| Image plane | ∞ | | | |

Table 22 shows a specification table of the zoom lens of Example 5.

TABLE 22

| | Wide-angle end | Intermediate | Telephoto end |
|---|---|---|---|
| f | 28.8064 | 74.9872 | 193.9857 |
| FNo. | 2.9014 | 4.4993 | 5.7496 |
| ω | 37.1023 | 15.3532 | 6.1514 |
| Y | 21.6330 | 21.6330 | 21.6330 |

Table 23 shows the distance of each variable interval of the zoom lens of Example 5.

TABLE 23

| | Wide-angle end | Intermediate | Telephoto end |
|---|---|---|---|
| d(0) | ∞ | ∞ | ∞ |
| d(5) | 1.5773 | 27.7653 | 55.0572 |
| d(12) | 24.4779 | 11.7651 | 1.4488 |
| d(21) | 4.2685 | 2.5440 | 1.1000 |
| d(26) | 1.2967 | 2.1596 | 1.9736 |
| d(28) | 11.8850 | 11.0222 | 11.2082 |
| d(34) | 0.8000 | 18.2640 | 28.5176 |
| d(0) | 53.0000 | 333.7851 | 608.0000 |
| d(5) | 1.5773 | 27.7653 | 55.0572 |
| d(12) | 24.4779 | 11.7651 | 1.4488 |
| d(21) | 4.2685 | 2.5440 | 1.1000 |
| d(26) | 4.4116 | 4.3239 | 7.6790 |
| d(28) | 8.7701 | 8.8579 | 5.5028 |
| d(34) | 0.8000 | 18.2640 | 28.5176 |

Table 24 shows the focal length of each lens group of the zoom lens of Example 5.

TABLE 24

| Group No. | Focal length |
|---|---|
| G1 | 109.4860 |
| G2 | −21.8790 |
| G3 | 1306.1700 |
| G4 | 19.4722 |
| G5 | −47.5671 |
| G6 | −60.5808 |
| G7 | 152.8530 |

Table 25 shows aspherical coefficients of aspheric surfaces in the zoom lens of Example 5.

TABLE 25

| Surface number | k | A4 | A6 |
|---|---|---|---|
| 6 | 0.0000 | 9.00415E−06 | 1.85580E−08 |
| 7 | 0.0000 | 5.04380E−06 | 3.14390E−09 |
| 19 | 0.6312 | 2.52959E−05 | −3.11325E−09 |
| 22 | 0.8967 | −1.75956E−05 | 5.94776E−08 |
| 23 | 0.0000 | 3.07843E−05 | −5.62021E−09 |
| 33 | 0.0000 | 5.23372E−06 | −5.24911E−08 |
| 34 | 0.0000 | 9.36697E−06 | −6.75384E−08 |

| Surface number | A8 | A10 | A12 |
|---|---|---|---|
| 6 | −1.23003E−10 | 3.25071E−13 | 0.00000E+00 |
| 7 | 4.60209E−10 | −4.09687E−12 | 1.29672E−14 |
| 19 | 2.16182E−10 | 2.79801E−12 | −1.75798E−14 |
| 22 | 3.07654E−10 | −4.13089E−12 | 1.57682E−14 |
| 23 | 8.06530E−10 | −6.27345E−12 | 2.02272E−14 |
| 33 | −3.31991E−10 | 3.41038E−12 | 0.00000E+00 |
| 34 | 2.11397E−10 | 3.02298E−13 | 0.00000E+00 |

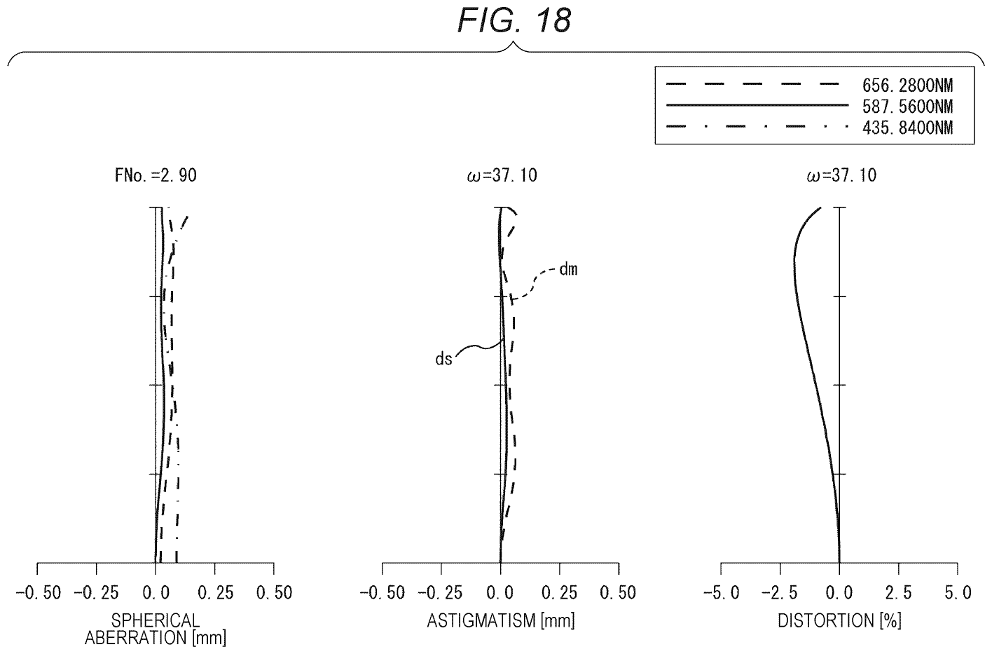

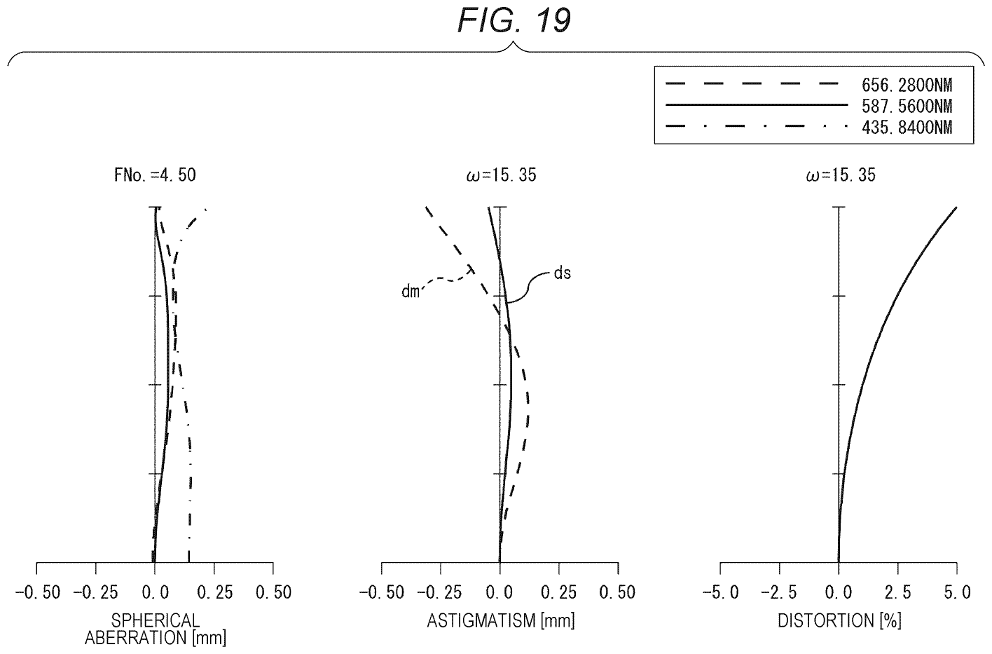

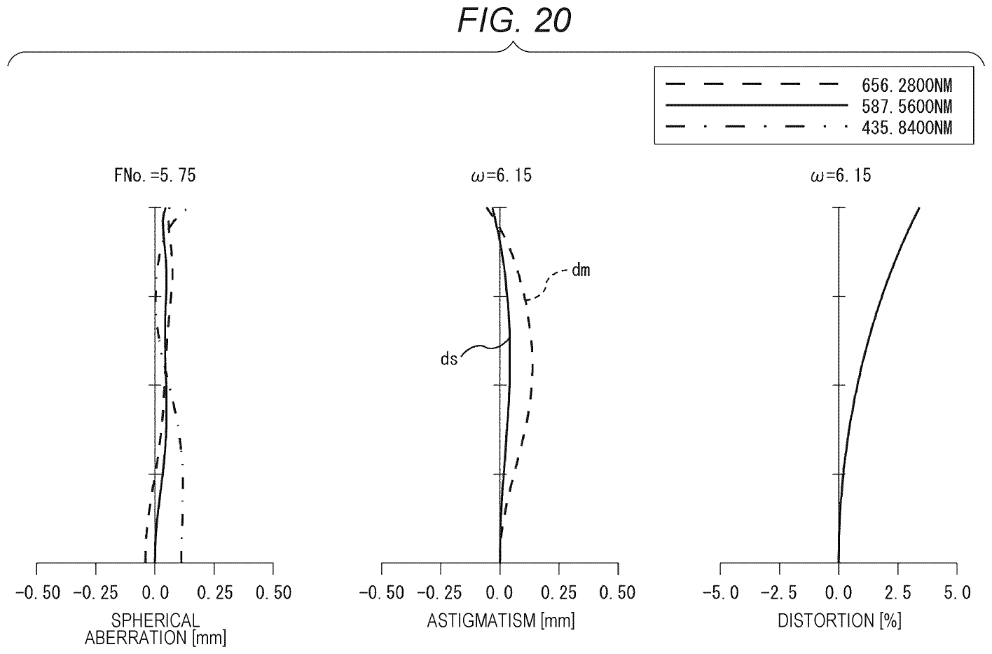

FIG. 18 illustrates a longitudinal aberration diagram of the zoom lens of Example 5 at a wide-angle end at a time of infinity focusing. FIG. 19 illustrates a longitudinal aberration diagram of the zoom lens of Example 5 at an intermediate focal point at a time of infinity focusing. FIG. 20 illustrates a longitudinal aberration diagram of the zoom lens of Example 5 at a telephoto end at a time of infinity focusing.

### Example 6

### (1) Configuration of Optical System

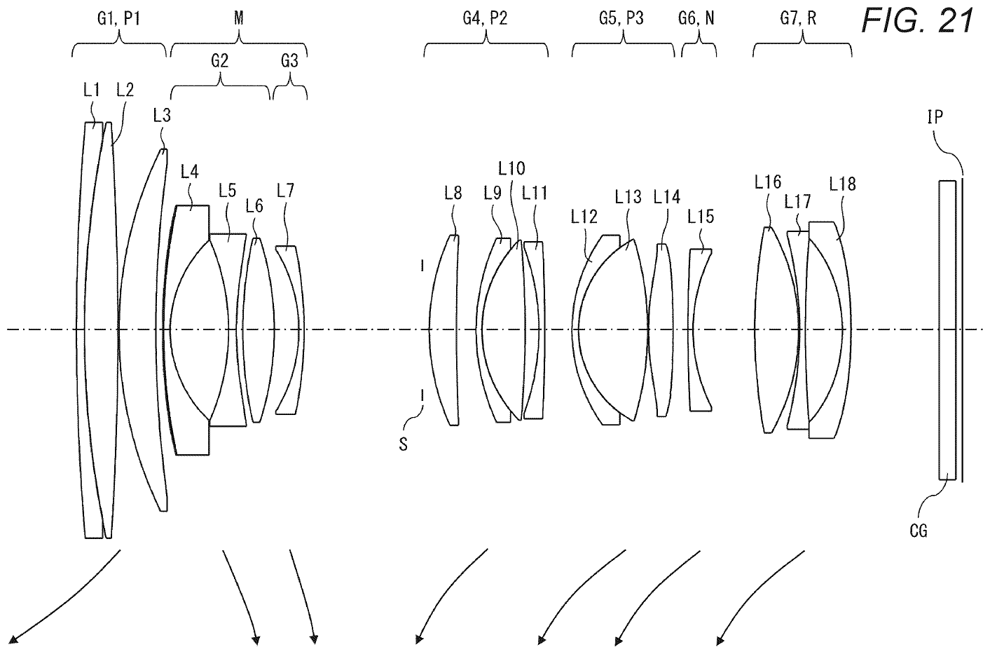

FIG. 21 is a diagram schematically showing an optical configuration of the zoom lens of Example 6 at a wide-angle end at a time of infinity focusing. The zoom lens according to Example 6 includes, in order from an object side, the first lens group G1 having positive refractive power, the second lens group G2 having negative refractive power, the third lens group G3 having negative refractive power, the fourth lens group G4 having positive refractive power, the fifth lens group G5 having positive refractive power, the sixth lens group G6 having negative refractive power, and the seventh lens group G7 having positive refractive power.

The first lens group G1 corresponds to the lens group P1 described above. The second lens group G2 and the third lens group G3 correspond to the middle group M described above. The fourth lens group G4 corresponds to the lens group P2 described above. The fifth lens group G5 corresponds to the lens group P3 described above. The sixth lens group G6 corresponds to the lens group N described above. The seventh lens group G7 corresponds to the rear group R described above. The meniscus lens L11 having negative refractive power corresponds to the lens component A described above.

The first lens group G1 includes, in order from the object side, a cemented lens of a meniscus lens L1 and a biconvex lens L2 having negative refractive power with a convex surface facing the object, and a meniscus lens L3 having positive refractive power with a convex surface facing the object.

The second lens group G2 includes, in order from the object side, the meniscus lens L4 having negative refractive power with a convex surface facing the object, the biconcave lens L5, and the biconvex lens L6. The meniscus lens L4 having negative refractive power is a composite resin aspherical lens in which a composite resin film molded in an aspherical shape is attached to an object side face.

The third lens group G3 includes the meniscus lens L7 having negative refractive power with a concave surface facing the object.

The fourth lens group G4 includes, in order from the object side, the meniscus lens L8 having positive refractive power with a convex surface facing the object, a cemented lens of a meniscus lens L9 and a biconvex lens L10 having negative refractive power with a convex surface facing the object, and the meniscus lens L11 having negative refractive power with a concave surface facing the object.

The fifth lens group G5 includes, in order from the object side, a cemented lens of the meniscus lens L12 and a biconvex lens L13 having negative refractive power with a convex surface facing the object, and the biconvex lens L14. The biconvex lens L14 is a glass molded aspherical lens both surfaces of which have an aspherical shape.

The sixth lens group G6 includes the meniscus lens L15 having negative refractive power with a convex surface facing the object.

The seventh lens group G7 includes the biconvex lens L16, the biconcave lens L17, and the meniscus lens L18 having negative refractive power with a concave surface facing the object. The negative meniscus lens L18 is a glass molded aspherical lens both surfaces of which have an aspherical shape.

The aperture stop S is disposed adjacent the fourth lens group G4 closer to the object.

The first lens group G1 corresponds to the lens group P1 described above. The second lens group G2 and the third lens group G3 correspond to the middle group M described above. The fourth lens group G4 corresponds to the lens group P2 described above. The fifth lens group G5 corresponds to the lens group P3 described above. The sixth lens group G6 corresponds to the lens group N described above. The seventh lens group G7 corresponds to the rear group R described above. The meniscus lens L11 having negative refractive power corresponds to the lens component A described above.

Arrows in FIG. 21 indicate a movement direction and a movement manner of each lens group of the zoom lens of Example 6 at the time of variable magnification from the wide-angle end to the telephoto end. In zooming from the wide-angle end to the telephoto end, the first lens group G1 moves toward the object, the second lens group G2 moves toward the image plane, the third lens group G3 moves toward the image plane, the fourth lens group G4 moves toward the object, the fifth lens group G5 moves toward the object, the sixth lens group G6 moves toward the object, and the seventh lens group G7 moves toward the object.

### (2) Numerical-Value Examples

Table 26 shows data of each surface included in the zoom lens of Example 6.

TABLE 26

| Surface number | r | d | nd | νd |
|---|---|---|---|---|
| Object surface | ∞ | d(0) | | |
| 1 | 370.1554 | 1.2000 | 1.92286 | 20.88 |
| 2 | 150.3426 | 5.1496 | 1.49700 | 81.61 |
| 3 | −476.6968 | 0.1500 | | |
| 4 | 63.0526 | 5.6352 | 1.71300 | 53.94 |
| 5 | 191.9941 | d(5) | | |
| 6ASPH | 97.5623 | 0.1500 | 1.53610 | 41.21 |
| 7 | 90.6798 | 1.0000 | 1.83481 | 42.72 |
| 8 | 18.7797 | 8.8963 | | |
| 9ASPH | −33.5783 | 1.2000 | 1.59201 | 67.02 |
| 10ASPH | 53.5806 | 0.9349 | | |
| 11 | 63.8828 | 4.7956 | 1.85883 | 30.00 |
| 12 | −46.1671 | d(12) | | |
| 13 | −23.4540 | 0.8000 | 1.49700 | 81.61 |
| 14 | −63.2605 | d(14) | | |
| 15S | ∞ | 1.0000 | | |
| 16 | 34.2676 | 4.1404 | 1.84666 | 23.78 |
| 17 | 269.5000 | 3.0015 | | |
| 18 | 33.4285 | 0.9000 | 2.00100 | 29.13 |
| 19 | 19.4500 | 6.5640 | 1.49700 | 81.61 |
| 20 | −152.5289 | 2.0904 | | |
| 21 | −36.3956 | 0.9000 | 2.00069 | 25.46 |
| 22 | −252.3384 | d(22) | | |
| 23 | 24.7246 | 1.0000 | 1.90043 | 37.37 |
| 24 | 15.6693 | 10.5231 | 1.59282 | 68.62 |
| 25 | −46.9021 | 0.1500 | | |
| 26ASPH | 38.5015 | 3.7059 | 1.59201 | 67.02 |
| 27ASPH | −155.3688 | d(27) | | |
| 28 | 208.9647 | 0.8000 | 1.83481 | 42.72 |
| 29 | 26.1008 | d(29) | | |
| 30 | 87.5342 | 6.6262 | 1.90110 | 27.06 |
| 31 | −31.8039 | 0.1500 | | |
| 32 | −56.6524 | 0.9000 | 1.85451 | 25.15 |
| 33 | 190.9861 | 5.6309 | | |
| 34ASPH | −25.1037 | 1.3000 | 1.69350 | 53.18 |
| 35ASPH | −77.1513 | d(35) | | |
| 36 | ∞ | 2.5000 | 1.51680 | 64.20 |
| 37 | ∞ | 1.0000 | | |
| Image plane | ∞ | | | |

Table 27 shows a specification table of the zoom lens of Example 6.

TABLE 27

| | Wide-angle end | Intermediate | Telephoto end |
|---|---|---|---|
| f | 24.7171 | 35.0035 | 67.9017 |
| FNo. | 2.9084 | 2.9087 | 2.9112 |
| ω | 43.1699 | 31.8220 | 16.8756 |
| Y | 21.6330 | 21.6330 | 21.6330 |

Table 28 shows the distance of each variable distance of the zoom lens of Example 6.

TABLE 28

| | Wide-angle end | Intermediate | Telephoto end |
|---|---|---|---|
| d(0) | ∞ | ∞ | ∞ |
| d(5) | 1.0000 | 6.7190 | 31.6762 |
| d(12) | 3.7810 | 3.6747 | 2.2945 |
| d(14) | 18.0647 | 10.3046 | 1.1734 |
| d(22) | 4.1524 | 2.3014 | 0.8000 |
| d(27) | 2.2946 | 2.4729 | 3.8855 |
| d(29) | 9.4133 | 9.2348 | 7.8225 |
| d(35) | 13.5000 | 21.1010 | 29.5541 |
| d(0) | 45.0000 | 141.3976 | 219.9999 |
| d(5) | 1.0000 | 6.7190 | 31.6762 |
| d(12) | 3.7810 | 3.6747 | 2.2945 |
| d(14) | 18.0647 | 10.3046 | 1.1734 |
| d(22) | 4.1524 | 2.3014 | 0.8000 |
| d(27) | 5.4558 | 4.4611 | 7.3945 |
| d(29) | 6.2522 | 7.2466 | 4.3135 |
| d(35) | 13.5000 | 21.1010 | 29.5541 |

Table 29 shows the focal length of each lens group of the zoom lens of Example 6.

| Group No. | Focal length |
|---|---|
| G1 | 118.4220 |
| G2 | −39.5535 |
| G3 | −75.5002 |
| G4 | 82.4445 |
| G5 | 22.5617 |
| G6 | −35.7995 |
| G7 | 305.1600 |

Table 30 shows aspherical coefficients of aspheric surfaces in the zoom lens of Example 6.

TABLE 30

| Surface number | k | A4 | A6 |
|---|---|---|---|
| 6 | 0.0000 | −4.85277E−07 | 7.14721E−09 |
| 9 | 0.0000 | 8.13071E−06 | −1.13425E−07 |
| 10 | 0.0000 | −4.17869E−06 | −1.10048E−07 |
| 26 | 4.6042 | −2.82667E−05 | −8.55996E−08 |
| 27 | 0.0000 | −9.01447E−07 | −6.76185E−08 |
| 34 | 0.8868 | −2.43431E−05 | 1.44228E−07 |
| 35 | 0.0000 | −2.32474E−05 | 1.29644E−07 |

| Surface number | A8 | A10 | A12 |
|---|---|---|---|
| 6 | −2.58125E−11 | 5.78287E−14 | 0.00000E+00 |
| 9 | 9.65317E−10 | −4.37798E−12 | 7.39167E−15 |
| 10 | 9.69284E−10 | −4.66443E−12 | 8.56193E−15 |
| 26 | −6.43844E−11 | −1.04820E−12 | 0.00000E+00 |
| 27 | −1.57302E−12 | −1.06441E−12 | 0.00000E+00 |
| 34 | −3.61210E−10 | 1.57287E−13 | 0.00000E+00 |
| 35 | −4.26328E−10 | 4.26440E−13 | 0.00000E+00 |

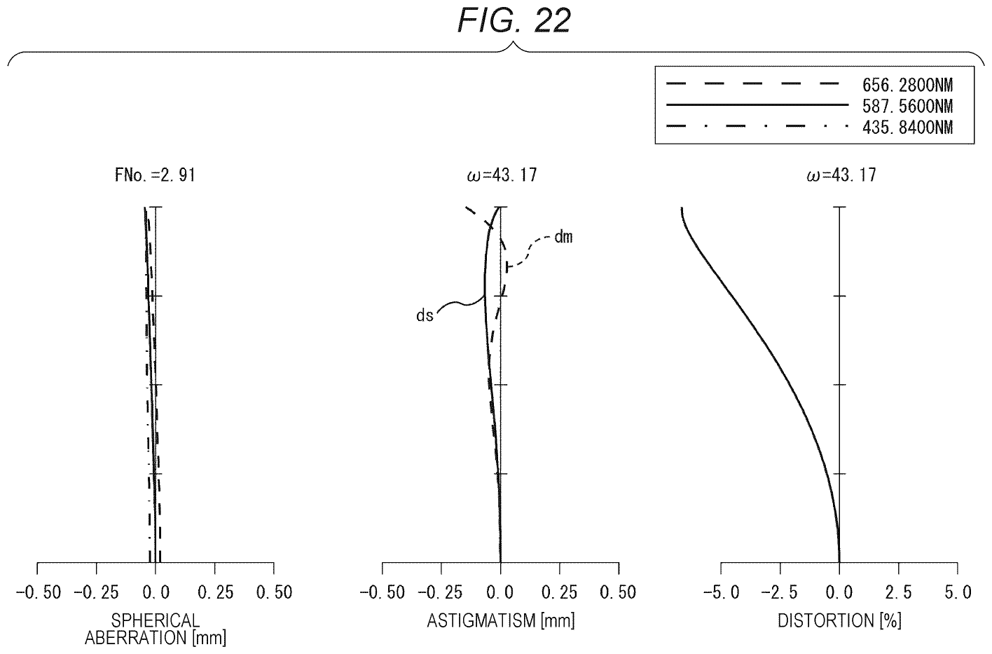

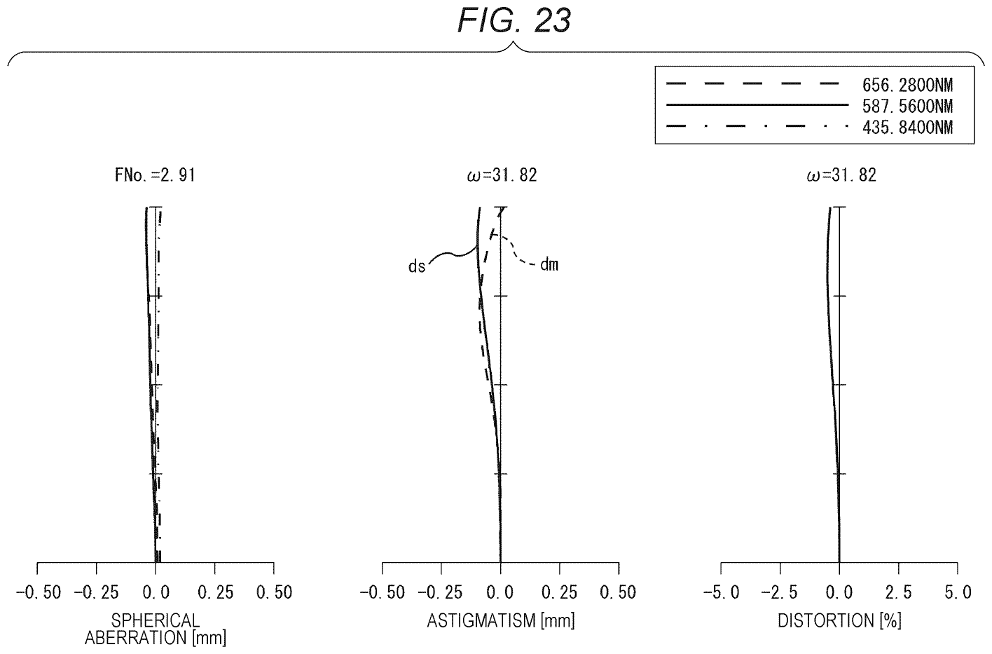

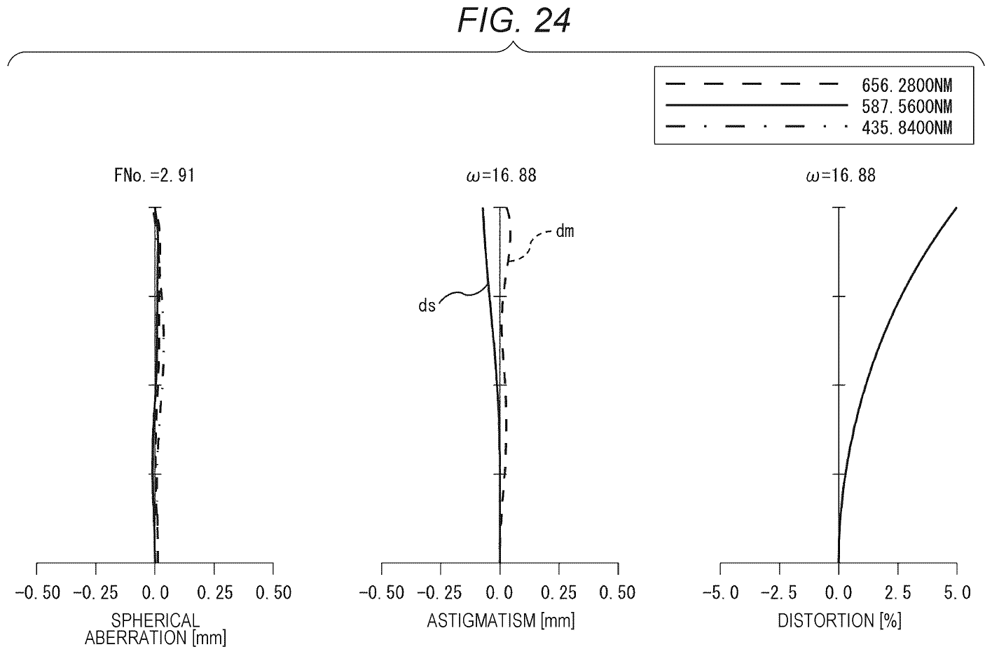

FIG. 22 illustrates a longitudinal aberration diagram of the zoom lens of Example 6 at a wide-angle end at a time of infinity focusing. FIG. 23 illustrates a longitudinal aberration diagram of the zoom lens of Example 6 at an intermediate focal point at a time of infinity focusing. FIG. 24 illustrates a longitudinal aberration diagram of the zoom lens of Example 6 at a telephoto end at a time of infinity focusing.

Table 31 shows calculated values according to the respective expressions described above in Example 1 to 6.

TABLE 31

| | Example | Example | Example | Example | Example | Example |
|---|---|---|---|---|---|---|
| | 1 | 2 | 3 | 4 | 5 | 6 |
| Expression (1) | −1.749 | −1.760 | −1.705 | −2.224 | −0.859 | −2.214 |
| Expression (2) | 0.737 | 0.746 | 0.746 | 0.746 | 0.746 | 0.746 |
| Expression (3) | −0.521 | −1.422 | −0.727 | −1.620 | −1.218 | −1.337 |
| Expression (4) | −0.197 | −0.527 | −0.210 | −0.585 | −0.023 | −0.517 |
| Expression (5) | 0.131 | 0.254 | 0.204 | 0.285 | 0.015 | 0.274 |
| Expression (6) | 0.867 | 0.898 | 0.880 | 0.861 | 0.676 | 0.913 |
| Expression (7) | 20.880 | 23.780 | 28.320 | 23.780 | 32.230 | 23.780 |
| Expression (8) | 4.074 | 4.610 | 4.598 | 4.505 | 3.801 | 4.791 |
| Expression (9) | 1.165 | 1.383 | 1.487 | 1.369 | 1.365 | 1.316 |
| Expression (10) | 1.144 | 1.532 | 1.536 | 1.923 | 0.806 | 1.938 |
| Expression (11) | 7.634 | 6.987 | 6.340 | 6.086 | 6.294 | 6.201 |

Table 32 shows values according to the respective expressions described above in Example 1 to 6.

TABLE 32

| | Example 1 | Example 2 | Example 3 | Example 4 | Example 5 | Example 6 |
|---|---|---|---|---|---|---|
| fp12w | −50.437 | −45.243 | −43.915 | −57.274 | −24.745 | −54.721 |
| bfw | 15.948 | 16.148 | 16.148 | 16.148 | 16.148 | 16.148 |
| Rf | −45.620 | −35.689 | −24.153 | −31.192 | −22.228 | −36.396 |
| Rb | 144.784 | −204.750 | 153.086 | −131.873 | −226.198 | −252.338 |
| fA | −37.495 | −47.966 | −23.256 | −45.532 | −30.257 | −42.589 |
| fp1 | 117.471 | 118.493 | 118.428 | 116.021 | 109.486 | 118.422 |
| fp2 | 190.165 | 90.992 | 110.976 | 77.880 | 1306.170 | 82.445 |
| fp3 | 24.995 | 23.085 | 22.674 | 22.174 | 19.472 | 22.562 |
| Tw | 165.148 | 151.148 | 137.148 | 131.648 | 136.148 | 134.148 |

What is claimed is:

1. A zoom lens consist of: a lens group P1 having positive refractive power; a middle group including one or more lens groups and having negative refractive power as a whole; a lens group P2 having positive refractive power; a lens group P3 having positive refractive power; a lens group N having negative refractive power; and a rear group including one or more lens groups all of which are disposed in order from an object side to an image plane side, wherein
the lens group P2 includes a lens component A, having negative refractive power, closest to an image plane, the lens component A has an object side face having a concave surface facing an object, and the zoom lens satisfies following Expression:
$$- 5.0 < fp 12 w / fw < - 0.3 \qquad ( 1 )$$
where
fp12w is a composite focal length of the zoom lens from the lens group P1 to the lens group P2 at a wide-angle end at a time of infinity focusing, and
fw is a focal length of the zoom lens at the wide-angle end at the time of infinity focusing.

2. The zoom lens according to claim 1, wherein the zoom lens satisfies following Expression:
$$0.5 < bfw / Yw < 1.5 \qquad ( 2 )$$
where
bfw is a back focus of the zoom lens at the wide-angle end at the time of infinity focusing, and
Yw is a maximum image height of the zoom lens at the wide-angle end at the time of infinity focusing.

3. The zoom lens according to claim 1, wherein the zoom lens satisfies following Expression:
$$- 5.0 < ( Rf + Rb ) / ( Rf - Rb ) < - 0.1 \qquad ( 3 )$$
where
Rf is a radius of curvature of a lens surface, of the lens component A, closer to an object, and
Rb is a radius of curvature of a lens surface, of the lens component A, closer to an image plane.

4. The zoom lens according to claim 1, wherein the zoom lens satisfies following Expression:
$$- 1.3 < fA / fp 2 < - 0.0 \; 01 \qquad ( 4 )$$
where
fA is a focal length of the lens component A, and
fp2 is a focal length of the lens group P2.

5. The zoom lens according to claim 1, wherein the zoom lens satisfies following Expression:
$$0.001 < fp 3 / fp 2 < 0 \text{.45} \qquad ( 5 )$$
where
fp3 is a focal length of the lens group P3. and
fp2 is a focal length of the lens group P2.

6. The zoom lens according to claim 1, wherein the zoom lens satisfies following Expression:
$$0.4 < fp 3 / fw < 1.3 \qquad ( 6 )$$
where
fp3 is a focal length of the lens group P3.

7. The zoom lens according to claim 1, wherein the zoom lens satisfies following Expression:
$$15 < v d < 40 \qquad ( 7 )$$
where
vd is an Abbe number of a lens, of the lens group P2, having positive refractive power, the lens being closest to the object, with respect to d Line.

8. The zoom lens according to claim 1, wherein the zoom lens satisfies following Expression:
$$2.5 < fp 1 / fw < 1 0. \qquad ( 8 )$$
where
fp1 is a focal length of the lens group P1.

9. The zoom lens according to claim 1, wherein the zoom lens satisfies following Expression:
$$0.7 < FNOp1\_ 3 < 1.9 \qquad ( 9 )$$
where
FNOp1_3 is a minimum value of an open F value in an entire zoom region from the lens group P1 to the lens group P3.

10. The zoom lens according to claim 1, wherein the zoom lens satisfies following Expression:
$$0.3 < β p 2 w < 5. \qquad ( 10 )$$
where
βp2w is a lateral magnification of the lens group P2 at the wide-angle end at the time of infinity focusing.

11. The zoom lens according to claim 1, wherein the zoom lens satisfies following Expression:
$$4. < Tw / Yw < 8.5 \qquad ( 11 )$$
where
Tw is an optical total length of the zoom lens at the wide-angle end at the time of infinity focusing.

12. The zoom lens according to claim 1, wherein the lens group P2 includes a cemented lens having a cemented surface with a convex surface facing the object.

13. The zoom lens according to claim 1, wherein the lens group P2 includes at least two lenses having positive refractive power and at least two lenses having negative refractive power.

14. The zoom lens according to claim 1, wherein the lens group N moves on an optical axis in focusing.

15. An imaging apparatus comprising: the zoom lens according to claim 1; and an image sensor that converts an optical image formed by the zoom lens on an image plane side of the zoom lens into an electrical signal.
